(19) United States
(12) Patent Application Publication
(10) Pub. No.: US 2007/0024462 A1
(43) Pub. Date: Feb. 1, 2007

(54) Electronics system

(75) Inventor: Masahiro Kitaura, Yokohama-shi (JP)

Correspondence Address: NATH & ASSOCIATES PLLC, 112 South West Street, Alexandria, VA, 22314, US

(73) Assignee: Victor Company of Japan, Limited, Yokohama-shi (JP)

(21) Appl. No.: 11/494,628

(22) Filed: Jul. 28, 2006

(30) Foreign Application Priority Data
Jul. 29, 2005 (JP) P2005-219744

(51) Int. Cl. H04N 7/00

(52) U.S. Cl. 340/825.22; 348/734; 348/705; 348/473

(57) ABSTRACT

An electronics system includes a television set and a plurality of external electronic devices connected to the television set. Each of the external electronic devices forms a two-dimensional positive synchronization signal, control codes for controlling the device, and icon data corresponding to the control codes, synthesizes the formed signal, control codes, and icon data with a video signal, and sends the synthesized video signal to the television set. The television set separates the control codes from the video signal, forms a control menu from the control codes, and displays the control menu. A user manipulates a remote controller of the television set to select an item in the control menu. The television set generates a remote control code corresponding to the selected item and sends the remote control code to remote controllers of the external electronic devices, thereby controlling an objective one of the external electronic devices.

### BACKGROUND OF THE INVENTION

1. Field of the Invention

The present invention relates to an electronics system involving a plurality of electronic devices including one with a display such as a television set or a personal computer. In particular, the present invention relates to an electronics system capable of remotely controlling electronic devices with an electronic device having a display.

2. Description of Related Art

In the 1980s, infrared remote controllers started to be attached to home appliances such as television sets. The remote control user-interfaces have widely spread and greatly changed the usage of home appliances. At present, the operation with remote controllers is in the mainstream. The remote controller basically employs a one-push, one-function operation. A television remote controller, for example, has ON/OFF, CHANNEL, VOLUME, and INPUT SELECT keys for conducting respective functions. The remote controller is very useful for remotely controlling the television set and electronic devices connected to the television set.

Data broadcasting that has started recently requires UP-DOWN-LEFT-RIGHT and OK keys of a remote controller to be pushed several times to display a required menu screen. An EPG (electronic program guide) includes a matrix of items to be chosen, and a user must push keys several times on a remote controller to record a program with the EPG. In this way, operation of the remote controller on the EPG is complicated and inconvenient like the operation on data broadcasting.

To solve the problems, Japanese Unexamined Patent Application Publication No. 2003-283866 discloses a controller that obtains positional information with a pointing unit such as a mouse, encodes the positional information into a time-series code string which is a time-series pattern of codes representative of pushed keys, and transmits the time-series code string to a television set.

The controller disclosed in the Japanese Unexamined Patent Application Publication No. 2003-283866 allows a user to conduct a pointing operation similar to a personal computer operation and remotely control a television set. This controller, therefore, is inconvenient for a person who is unfamiliar with a personal computer. From the view point of information literacy (ability of utilizing information), the related art is somewhat unreasonable in introducing the handling scheme of personal computers into the handling scheme of home appliances such as television sets. A need exists in a new remote control appropriate for the present way of use of television sets.

Due to an advancement of networking, displays of television sets and personal computers must display a variety of information pieces supplied from storage media and the Internet. In this case, operation of a remote controller of a television set is dependent on information sources, and the remote controller must cope with various information sources. In this regard, present remote controllers attached to home appliances are insufficient.

Under such circumstances, the inventor of the present invention has proposed an electronic device controller capable of flexibly, conveniently, and remotely controlling a variety of electronic devices without a handheld remote controller. This electronic device controller forms a graphical user interface (GUI) on a display of, a television set and allows a user to conveniently conduct a pointing operation from a distance with respect to the GUI.

This new controller can control networked electronic devices which are connected to one another through digital interfaces to realize two-way communication. To control a network device connected to a television set, a menu for controlling the network device must be displayed on the television set through a digital interface and control information chosen on the menu must be fed back to the network device through the digital interface. There are various types of digital interfaces and it is difficult to cope with all digital interfaces and control protocols in terms of cost and development. Connection of conventional analog devices to a television set is based on one-way communication, and therefore, it is difficult for the television set to acquire control information of the analog devices through the one-way connection.

In the digital interface field, endeavors are actively made to develop integrated protocols that can control networked electronic devices. At present, however, there are no protocols generally applicable to home networks. There is a need of network control method and apparatus that are inexpensive, simple, and applicable to home audio and vide devices.

The above-mentioned electronic device controller proposed by the present applicant employs a remote operation unit having a pointing function, to improve the usability of a television set particularly when the television set receives a variety of broadcasting programs. Controlling network devices connected to a television set needs to handle various network control protocols. Industries concerned have tackled to standardize and spread protocols for controlling networked devices. The endeavors are not successful yet. FIG. 1 is a view explaining problems related to operation of a conventional television set and electronic devices connected thereto. The television set 1 is connected to four external electronic devices 2 through analog or digital interfaces. The devices 2 have remote controllers 4, respectively, to control the devices 2. The number of remote controllers will increase as the number of analog/digital devices connected to the television set 1 increases. This problem is perceived by a user when the user struggles to find a right controller of an objective device such as a VTR, video disk, audio unit, or the like connected to the television set.

FIG. 2 is a view showing connections between a conventional television set and external electronic devices. An iLink (IEEE1394) is a digital interface that is secure (5C-DTCP) and is capable of conducting real-time (isochronous) stream transfer. The iLink connects devices on equal conditions and allows any one of the connected devices to serve as a host. The iLink is widely used among AV devices that work on AVC protocols. In connection with the iLink, there are HAVi (Home Audio/Video interoperability) protocols and middleware, to realize interconnection among devices with the iLink. The HAVi is not popular yet. For use with personal computers, there are Ethernet (registered trade name) using a LAN, HomePNA (Home Phone Line Networking Alliance) using an existing telephone line, USB (universal serial bus), and the like. These connection methods are used for AV devices. Actively used for AV devices is HDMI (High-Definition Multimedia Interface). The HDMI employs a CEC (Consumer Electronics Control) line to transfer control protocols which are not defined yet. Portable terminals such as notebook personal computers, cellular phones, and PDAs pay attention to a Bluetooth connection method employing a 2.4-GHz band usable without a license. Another wireless connection method expected for use with home AV devices is a UWB (Ultra Wide Band) that is faster than the Bluetooth or a wireless LAN (IEEE802.11b).

These connection methods have a problem of interconnectivity among them. To cope with the problem, AV devices must have a function of relaying video and audio data between different methods and a function of converting a control protocol into another. This increases the cost of AV devices, makes the use of them inconvenient, and diminishes the benefit of users. Integrating the existing digital interfaces may realize a real-time transfer of video and audio data. For this, parties concerned are making efforts to standardize control protocols. No fruit, however, is provided yet. Presently, each of interconnected devices must have a remote controller to control the same.

For video and audio signals of analog interface devices, a pin-jack-cable connection method has been established from an early stage and is widely used at present. For data transfer among analog interface devices, there is a VIB (Vertical Interval Blanking) method that transfers data in a vertical blanking interval. The VIB data transfer is only in one direction, and therefore, remote controllers are needed for two-way control. Namely, each of the devices connected through analog interfaces must be provided with one remote controller, like the devices connected through digital interfaces.

In this way, the existing digital interfaces are not widely used because they are based on different standards and there are no unified control protocols for them although the digital interfaces have a capability of conducting two-way control data transfer. In addition, the existing digital interfaces have no continuity to the existing analog interfaces. Consumer electronic devices such as AV devices need, when they are connected to a television set, a control method for uniformly controlling them without using their respective remote controllers.

### SUMMARY OF THE INVENTION

An object of the present invention is to provide an electronics system involving a display electronic device and external electronic devices connected to the display electronic device, capable of controlling the electronic devices in a consolidated manner with a remote controller attached to the display electronic device or through the display electronic device without regard to connection methods among the electronic devices.

In order to accomplish the object, a first aspect of the present invention provides an electronics system including at least one first electronic device with a display and at lest one second electronic device connected to the first electronic device. The second electronic device has an information adder configured to add a synchronization signal and additional information containing information necessary for controlling the second electronic device to a predetermined area of a video signal to be transmitted to the first electronic device. The first electronic device has an extractor configured to extract the additional information from the video signal transmitted from the second electronic device, a control information provider configured to display, according to the extracted additional information, control information for controlling the second electronic device on the display, and a forwarder configured to forward a control information piece to the second electronic device once the control information piece is selected by an operator from the control information displayed on the display. The second electronic device carries out a control operation according to the forwarded control information piece.

According to the first aspect, a synchronization signal and additional information containing information necessary for controlling the second electronic device are added to a predetermined area of a video signal, and the added video signal is transmitted from the second electronic device to the first electronic device. The first electronic device extracts the added information from the video signal, and according to the extracted information, displays control information for controlling the second electronic device on the display. An operator manipulates a remote controller of the first electronic device and selects a control information piece from among the displayed control information. The control information piece selected by the operator is forwarded from the first electronic device to the second electronic device, to control the second electronic device. In this way, the operator can control the second electronic device with the remote controller of the first electronic device or an operation carried out on the first electronic device. The first aspect makes a remote controller of the second electronic device unnecessary and improves operability of the electronics system as a whole.

According to a second aspect of the present invention, the forwarder is configured to forward the selected control information piece to the second electronic device through an infrared remote controller.

According to the second aspect, the control information piece selected by the operator is forwarded to the second electronic device through an infrared remote controller. Namely, the second aspect uses codes of commercial remote controllers, to control electronic devices. The second aspect eliminates the need of planning new standards and makes it easy to introduce the electronics system of the present invention.

According to a third aspect of the present invention, the information adder is configured to search an area of the video signal outside the predetermined area for the same pattern as the synchronization signal, and if the same pattern is found, change the part of the video signal in which the same pattern is found.

According to the third aspect, the information adder searches an area of the video signal outside the predetermined area for the same pattern as the synchronization signal, and if finds the same pattern, changes the part of the video signal in which the same pattern has been found. This prevents the part of the video signal from being erroneously detected as the synchronization signal and surely transmits the added information to the first electronic device.

According to a fourth aspect of the present invention, the additional information added by the information adder includes icon information to be used to control the second electronic device, and the control information provider is configured to display icons on the display according to the icon information, the icons serving as the control information.

According to the fourth aspect, the additional information includes icon information, and according to the icon information, icons are displayed on the display. The icons are smart on the display and allow an operator to easily choose a required operation of the second electronic device.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a view explaining relationships among a television set, external electronic devices, and remote controllers according to a related art;

FIG. 2 is a view showing various connection methods between a television set and external electronic devices according to a related art;

FIG. 3 is a view showing a typical arrangement of a television set and external electronic devices according to a related art;

FIG. 4 is a view showing a menu screen displayed on a television set;

FIG. 5 is a view showing a menu screen for an external electronic device connected to a television set;

FIG. 6 is a view showing a connection panel of a television set;

FIG. 7 is a view explaining operation of an external electronic device with an external device remote controller;

FIG. 8 is a view showing connections among a television set, external electronic devices, and external device remote controllers;

FIG. 9 is a view explaining a method of replacing control codes with icons in a menu screen for controlling an external electronic device;

FIG. 10 is a view explaining specified amplitudes of analog and digital video signals;

FIGS. 11A and 11B are views explaining correlativity of standard images in an image space;

FIG. 12 is a view showing waveforms representative of a two-dimensional positive synchronization signal and control code included in the first to twelfth lines of an image signal;

FIG. 13 is a view showing waveforms representative of control codes included in the thirteenth to twenty-fourth lines of an image signal;

FIGS. 14A to 14C are views explaining a code format and a method of extracting data;

FIGS. 15A and 15B are views showing code data displayed on a television set;

FIG. 16 is a table showing three formats of remote control codes;

FIG. 17 is a block diagram showing a synchronization signal detector to detect a two-dimensional positive synchronization signal and generate control timing pulses;

FIG. 18 is a timing chart explaining operation of the synchronization signal detector of FIG. 17;

FIGS. 19A and 19B are views explaining a relationship between a reference synchronization signal extracted by the synchronization signal detector of FIG. 17 and a timing pulse obtained from the reference synchronization signal and used for acquiring codes;

FIG. 20 is a view explaining data capture from an odd field;

FIGS. 21A and 21B are timing charts showing icon transfer timing;

FIG. 22 is a block diagram partly showing a television set and an external electronic device, according to a first embodiment of the present invention;

FIG. 23 is a block diagram showing an erroneous synchronization detection protector shown in FIG. 22;

FIG. 24 is a view showing waveforms of a video signal changed by the erroneous synchronization detection protector of FIG. 23;

FIG. 25 is a block diagram partly showing a television set and an external electronic device, according to a second embodiment of the present invention;

FIG. 26 is a block diagram showing a synthesizer of the external electronic device shown in FIG. 25;

FIGS. 27A and 27B are views showing code data according to the second embodiment of the present invention, displayed on a television set;

FIGS. 28A and 28B are views showing examples of screens displayed on a television set, according to the present invention;

FIG. 29 is a view showing an example of an EPG screen displayed on a television set, according to the present invention; and

FIG. 30 is a view showing an electronics system employing an infrared repeater according to the present invention.

### DETAILED DESCRIPTION OF EMBODIMENTS

Embodiments of the present invention will be explained with reference to the accompanying drawings.

To realize integrated operation of home electronic devices, a display device such as a television set or a personal computer must display operation information of the electronic devices connected to the display device. Among home appliances, a television set may serve as a center unit to realize integrated easy operation of, for example, AV devices and other devices connected to the television set. To achieve this, a home appliance GUI is necessary. It is impossible for the television set to incorporate functions of controlling every electronic device to be connected to the television set because information on such a variety of electronic devices is unavailable. Instead, the television set may display a control menu for any electronic device connected to the television set and a user may conduct remote control with respect to the control menu. Namely, the television set gathers control information of electronic devices connected thereto so that a user may conveniently control through the television set every electronic device connected to the television set. For this, the present invention provides an electronics system that realizes a universal network GUI. According to an embodiment of the present invention, an external electronic device connected to a television set transmits a control menu to the television set in real time. The control menu is displayed on the television set and a user selects a required item from the control menu. The selected item is fed back as control information to the external electronic device, to control the external electronic device. The present invention realizes this sort of two-way communication without regard to connection methods.

A first embodiment of the present invention relates to a universal network GUI (graphical user interface) that has an affinity for every connection method by satisfying five conditions including continuity to conventional analog interfaces, an affinity for various digital interfaces, independence from control protocols, and integrated control with a single remote controller. The universal network GUI is the gist of the present invention. A second embodiment of the present invention relates to a system that excludes the continuity to analog interfaces from the five conditions and supports only digital interfaces.

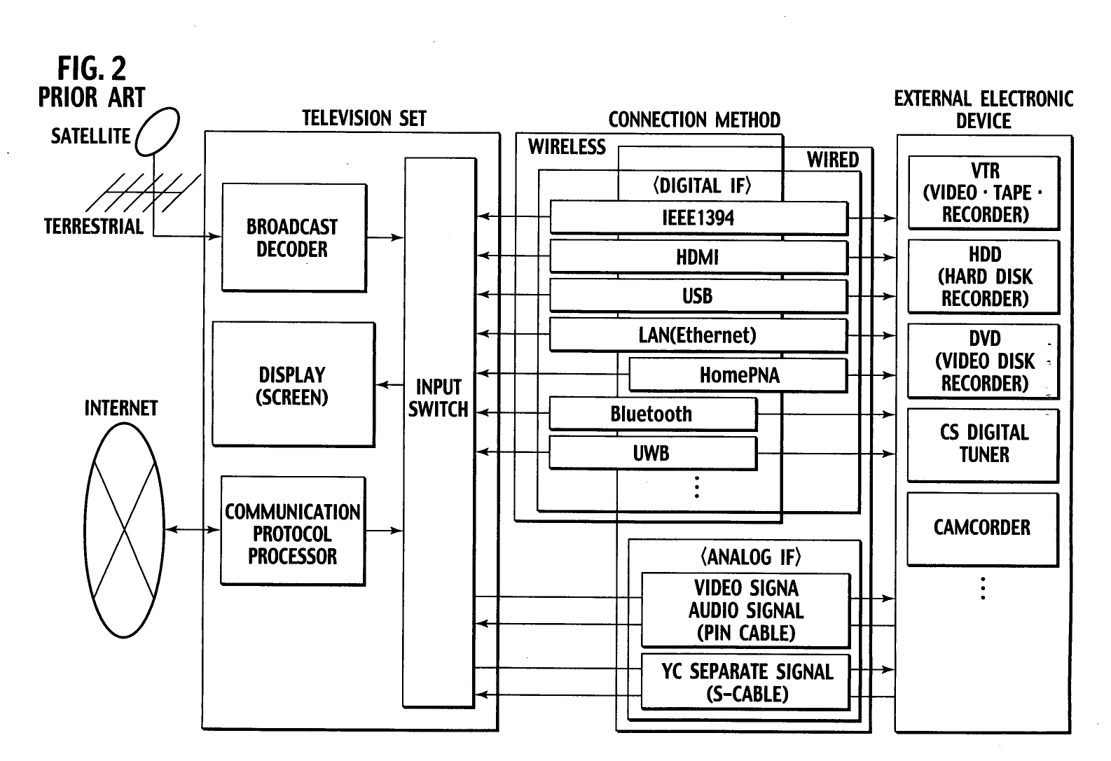

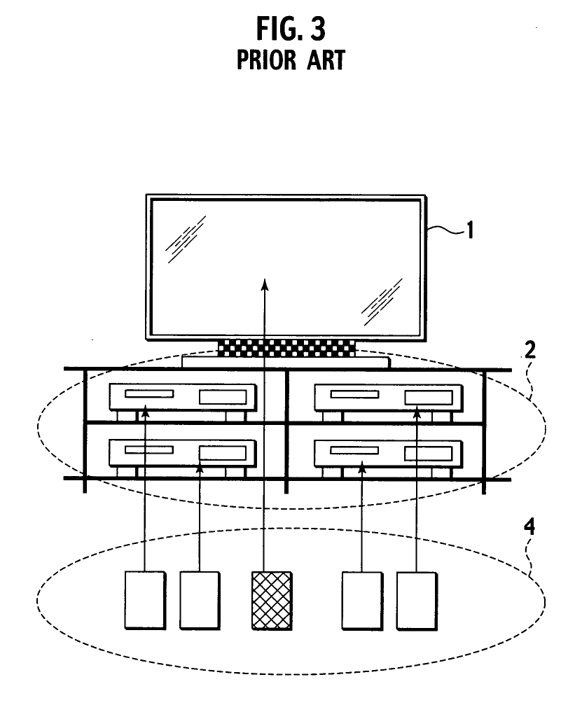

FIG. 3 is a view showing typical home connections according to a related art. In FIG. 3, a television set 1 is connected to four external electronic devices 2 that are arranged on a rack. The television set 1 and external electronic devices 2 are controlled with remote controllers 4, respectively. The external electronic devices 2 may include a video tape recorder, a video disk recorder, a hard disk recorder, a CATV terminal adapter, and the like. The television set 1 has tuners for terrestrial, CS, and BS RF signals (modulated signals). The television set 1 and external electronic devices 2 are connected to each other through analog and/or digital interfaces according to the first embodiment of the present invention, and through digital interfaces according to the second embodiment of the present invention. The interfaces may be wireless or wired. Video data is transmitted in an analog form or a digital form. The analog or digital transmission of video data is achievable in every connection of FIG. 2 and in any existing AV connection.

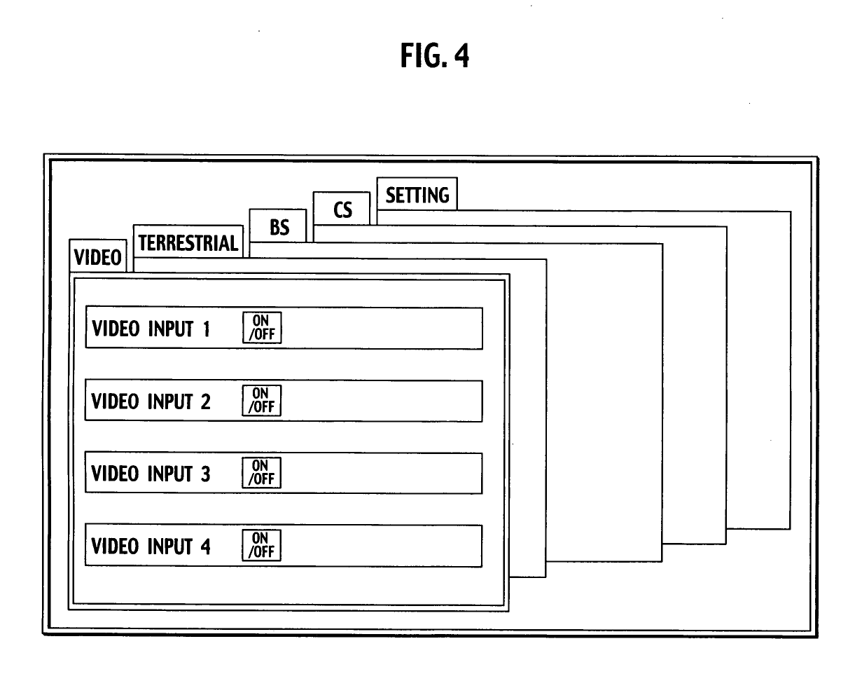

FIG. 4 shows examples of control menus displayed on the television set 1. The control menus include a video menu, a terrestrial broadcasting menu, a BS menu, a CS menu, and a setting menu. In FIG. 4, the video menu is on top of the control menus and allows a user to select one of the external electronic devices 2 connected to the television set 1. The terrestrial broadcasting, BS, and CS menus are used to switch a channel to another by controlling tuners in the television set 1. The terrestrial broadcasting, BS, and CS menus are specific to the television set 1, and therefore, have no problems in GUI control. Similarly, the setting menu is to variously set the television set 1, and therefore, has no problems in GUI control.

The GUI control problems exist in the video menu used to select one of the external electronic devices 2. In FIG. 4, the television set 1 has four video inputs to which the four external electronic devices 2 shown in FIG. 3 are connected. If no external electronic device is selected, an operation object is in the television set 1, and therefore, there will be no control problem. Once one of the video inputs 1 to 4 is selected, an operation object will be shifted to the electronic device corresponding to the selected video input. According to the related art, any function specific to the television set 1 is controlled with the remote controller of the television set 1, and the external electronic device 2 of the selected video input is controlled with the remote controller of the external electronic device 2. Namely, the user must pick up a proper one of the remote controllers of the four external electronic devices 2. In FIG. 4, there are five remote controllers including one for the television set 1 and four for the external electronic devices 2. The present invention enables remote control of the external electronic devices 2 to be simply carried out with the remote controller of the television set 1 or through the television set 1. Namely, the present invention can commonly control the system of FIG. 3 with a single remote controller.

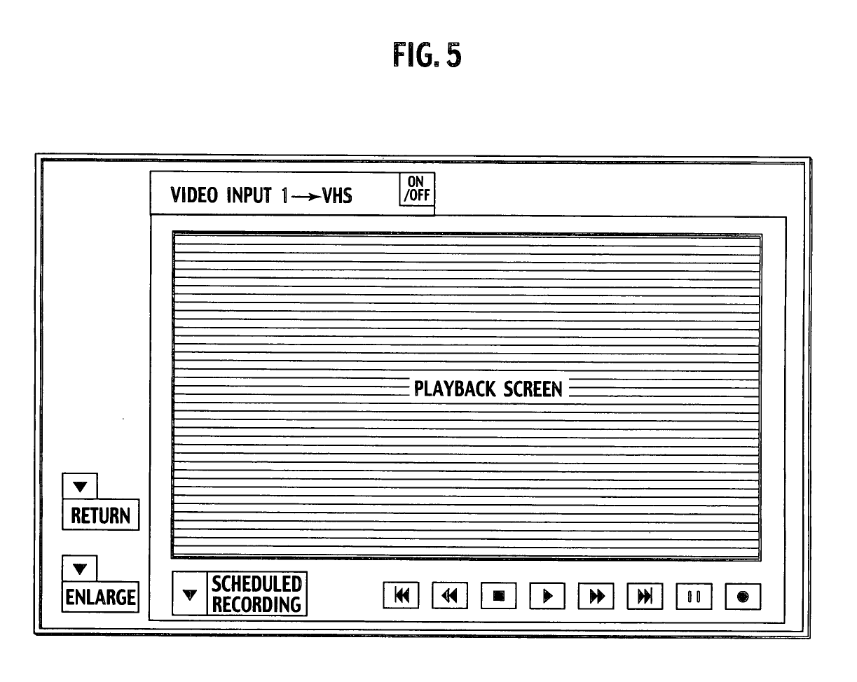

FIG. 5 shows an example of a control menu displayed when the video input 1 is chosen in the control menu of FIG. 4. In FIG. 5, “Video input 1→VHS” indicates that the video input 1 is connected to a VHS (registered trade name of this applicant) video tape recorder. The control menu of FIG. 5 also includes a playback screen of a video tape, an ON/OFF button, a play icon, a stop icon, a program setting button, and the like. Also included in the control menu of FIG. 5 are a RETURN button to restore the preceding control menu and an ENLARGE button to enlarge the playback screen. The information pieces in the control menu of FIG. 5 are related to only the video tape recorder connected to the video input 1 and are obtainable through a video cable in the case of an analog connection or from video data in the case of a digital interface connection. In this way, video images can be transferred to the television set 1 through an analog or digital interface. Problems exist in finding the positions of control items in the control menu, recognizing the contents of control items, and feeding a selected control item back to the external electronic devices 2. These problems are solved by the universal network GUI of the present invention.

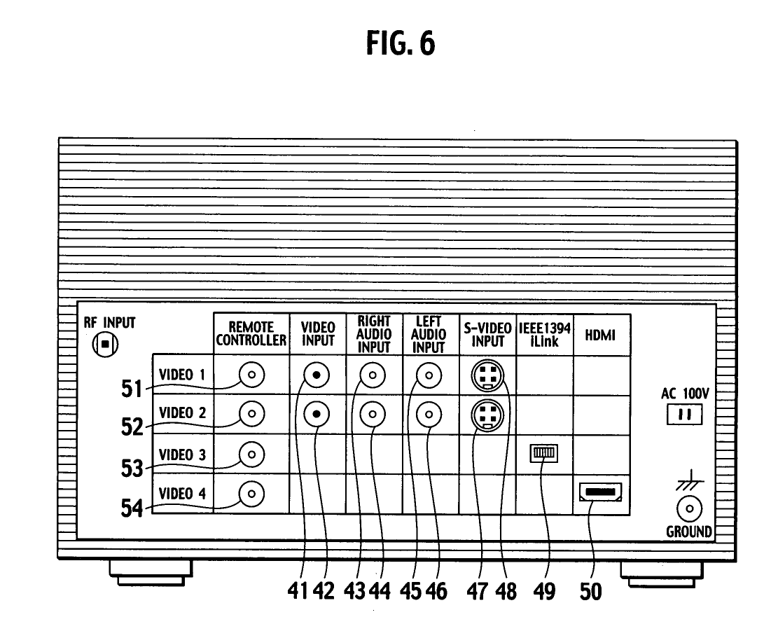

FIG. 6 shows a connection panel on the back of the television set 1. There are connection terminals of video 1 to video 4 to accept the four external electronic devices 2. The video 1 and video 2 are of analog connections and include input video terminals 41 and 42, right and left audio pin jack cable terminals 43 to 46, and input S-video terminals 47 and 48 for separately receiving luminance and carrier chrominance signals through S-cables. The video 3 is of a digital interface and includes an IEEE1394 (iLink) connection terminal 49. The video 4 is of a digital interface and includes an HDMI connection terminal 50. The video 1 to video 4 have external remote controller terminals 51 to 54, respectively.

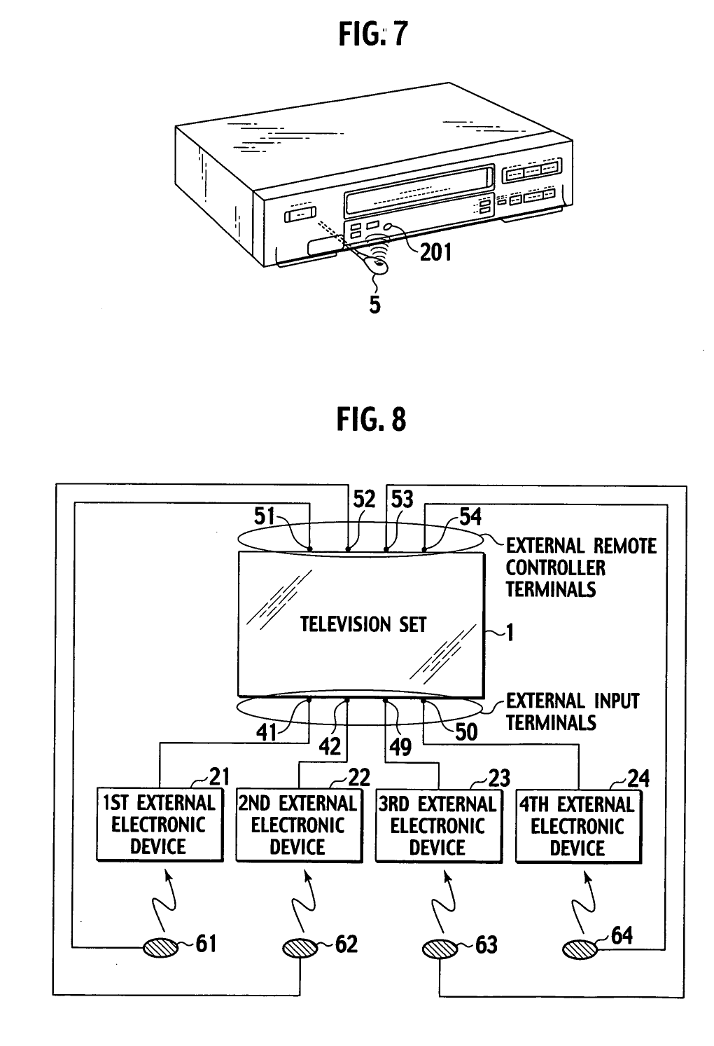

FIG. 7 shows a video deck, which is one of the external electronic devices 2 connected to the television set 1, and an external device remote controller 5 connected to the corresponding external remote controller terminal of the television set 1. The remote controller 5 is used to control the external electronic device, such as recording a program with a CS digital tuner. In FIG. 7, the remote controller 5 emits infrared rays, which are received by a sensor 201 of the external electronic device so that control information is transferred from the remote controller 5 to the external electronic device.

FIG. 8 is a block diagram showing the television set 1, external electronic devices connected thereto, and external device remote controllers. The control menu of FIG. 5 is based on a video signal transferred from the first external electronic device 21 to the television set 1. The second to fourth external electronic devices 22, 23, and 24 are also connected to the connection terminals of the television set 1. As mentioned above, the third and fourth external electronic devices 23 and 24 are of digital interfaces. Namely, the electronics system according to the present invention can accept various connection methods.

In FIG. 8, there are four external device remote controllers 61 to 64. The four external electronic devices 21, 22, 23, and 24 are connected to the terminals 41, 42, 49, and 50, respectively, on the back panel of the television set 1 (FIG. 6). The four remote controllers 61 to 64 are connected to the terminals 51 to 54, respectively, on the back panel of the television set 1 (FIG. 6).

The television set 1 can control the external electronic devices 21 to 24 connected thereto with the use of the external device remote controllers 61 to 64 employing infrared rays. Namely, the infrared remote controller attached to the television set 1 is used to manipulate a control menu displayed on the television set 1, to control the external electronic devices 21 to 24 through the remote controllers 61 to 64 like controlling the television set 1. Any function achievable with the remote controllers 61 to 64 of the external electronic devices 21 to 24 connected to the television set 1 can be carried out with the remote controller of the television set 1. This control scheme is realized through the universal network GUI of the present invention. Although the example of FIG. 8 includes four external device remote controllers 61 to 64, a single external device remote controller may be sufficient if there is no problem in the directivity of infrared rays. The television set 1 and external electronic devices 2 of FIG. 8 are arranged on the rack of FIG. 3, and therefore, the external electronic devices are provided with their respective remote controllers.

The television set 1 and external electronic devices 21 to 24 shown in FIG. 8 are connected to each other through analog or digital interfaces, so that images from the external electronic devices 21 to 24 are displayed on the television set 1 and control of the external electronic devices from the television set 1 is carried out through the external device remote controllers 61 to 64. In this scheme, control menus of the external electronic devices 21 to 24 are transmitted from the devices 21 to 24 to the television set 1 with video signals. An important point is how to transmit control information of the external electronic devices 21 to 24 from the devices 21 to 24 to the television set 1. Generally, data transfer to a television set through an analog interface is carried out by overlaying the data over a vertical blanking interval. For this, there are standards such as STD-B5 (standard television/data multiplex broadcasting employing vertical blanking intervals) prepared by ARIB (Association of Radio Industries and Businesses) and a video ID signal transmission method (525-line system) employing CPR-1204 VBI, a video ID signal transmission method (525P system) employing CPR-1204-1 VBI, and a video ID signal transmission method (750P, 1125i system) employing CPR-1204-2VBI prepared by JEITA (Japan Electronics and Information Technology Industries Association). These are used as standards for facsimile signals, telesoftware signals, still image signals, character signals, time signals, display control data signals, and the like. Also, there is a method of varying a synchronization signal for a copy guard system. This is not a data transfer method but it may interfere with data inserted in vertical blanking intervals. To control the external electronic devices 21 to 24, any method of multiplexing control data into vertical blanking intervals is unacceptable because such a method conflicts with each of the data multiplexing methods. Establishing new standards for the control data of external electronic devices must build a consensus among industries concerned, and therefore, needs time and labor. Accordingly, inventing an original method of including control data in video signals is the earliest way to improve the usability of a system involving a display electronic device and external electronic devices.

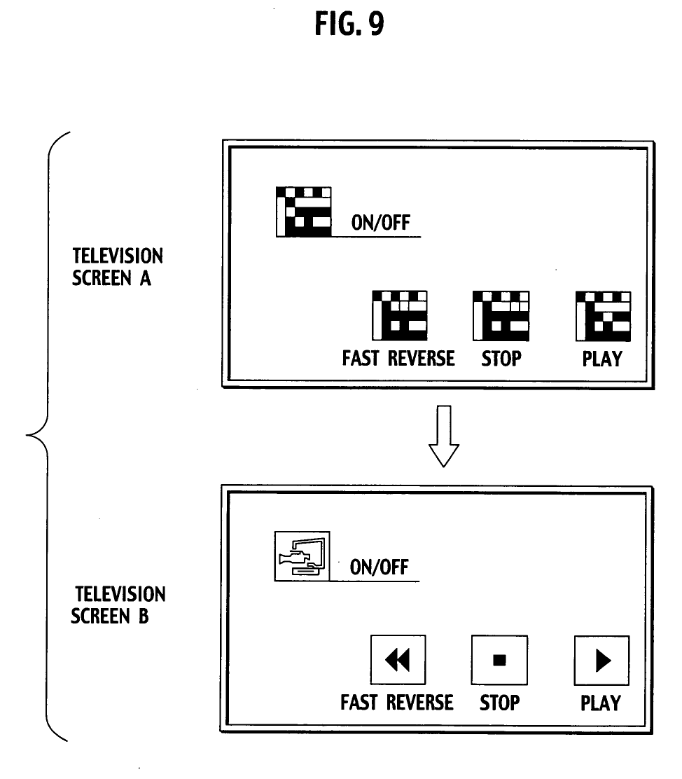

FIG. 9 shows control data embedded in an effective area (outside a blanking area) of a video signal. In FIG. 9, a television screen A displays the control data as it is with a synchronization signal and control codes being seen as they are, and a television screen B displays icons representative of the control codes, which have been decoded and replaced with the proper icons. The icons are similar to those used for a personal computer and are useful for guiding a user to proper operation. In the screen A of FIG. 9, the function of each code is represented with a character string such as “Play.” In this case, icons may be omitted without causing inconvenience.

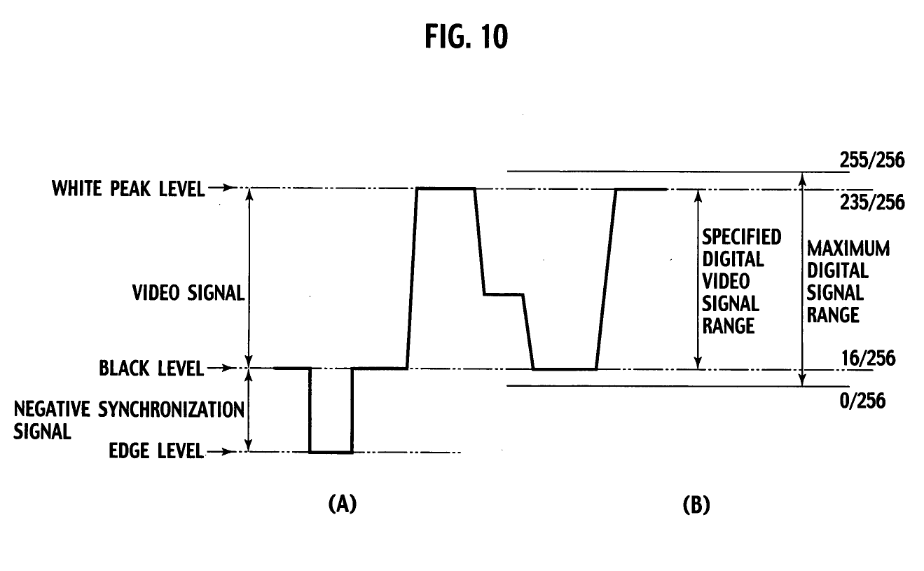

To display control codes as in FIG. 9, positional information for displaying the codes is needed. Generally, a synchronization signal used to obtain positional information is a negative synchronization signal which can be discriminated and extracted from a video signal by level slicing. Part (A) of FIG. 10 shows a negative synchronization signal used with a video signal for analog connection. The present invention must avoid to employ the same synchronization method. Part (B) of FIG. 10 shows a digital component video signal for digital interface or for digital broadcasting and package media. This video signal defines black and white peak levels with respect to the dynamic range thereof and considers nothing about a negative synchronization signal. In consideration of these situations, the universal network GUI according to the present invention employs a two-dimensional positive synchronization method. This method separates a two-dimensional positive synchronization signal from a video signal or any other signal according to statistical characteristics.

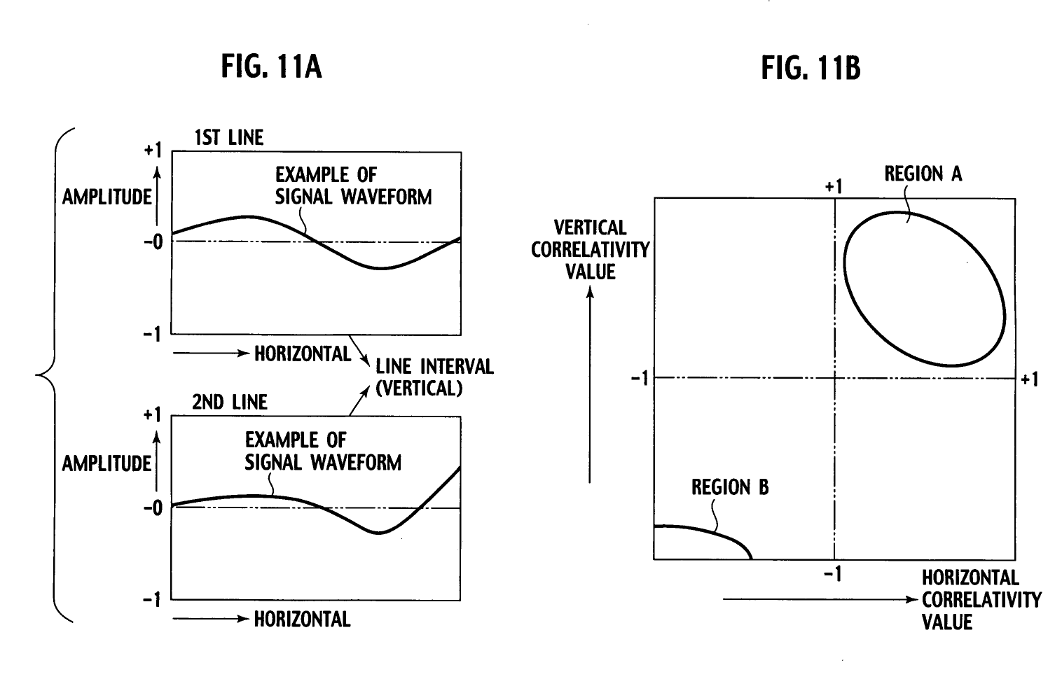

FIGS. 11A and 11B are views explaining image correlativity. FIG. 11A shows typical amplitude changes in first and second lines (each line corresponding to a horizontal period) with an amplitude center being at level 0 and amplitude peaks at levels +1 and −1. In a vertical direction, correlativity is measured between adjacent lines, and in a horizontal direction, correlativity is measured between adjacent pixels or between pixels that are away from each other by several pixels. A correlativity value in a vertical direction is obtained by multiplying the amplitude of a pixel on the first line by the amplitude of a pixel at the same position but on the second line. A correlativity value in a horizontal direction is obtained by multiplying the amplitudes of first and second pixels that are adjacent to each other or are separated away from each other by several pixels in the horizontal direction. FIG. 11B is a correlativity map plotting the vertical and horizontal correlativity values thus obtained. An image has a statistical characteristic that pixels which are close to each other have higher correlativity and pixels which are away from each other have lower correlativity. Namely, correlativity values of a typical image frequently appear in a region A in the first quadrant of FIG. 11B, and waveforms with no correlativity appear in a region B that is in the third quadrant and is away from the origin. The present invention employs a waveform in the region B of the third quadrant for a two-dimensional positive synchronization signal so that the signal is easily distinguished from images.

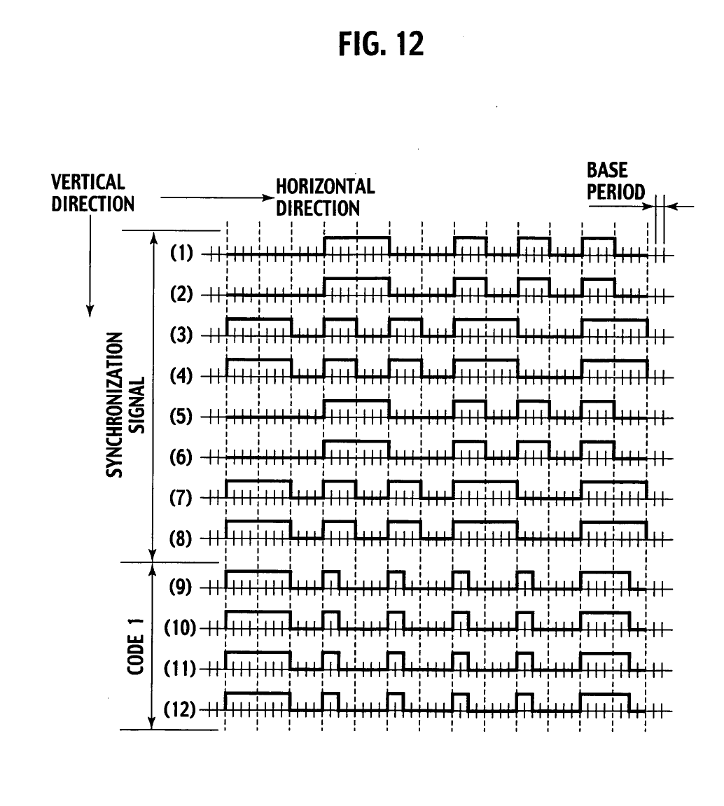

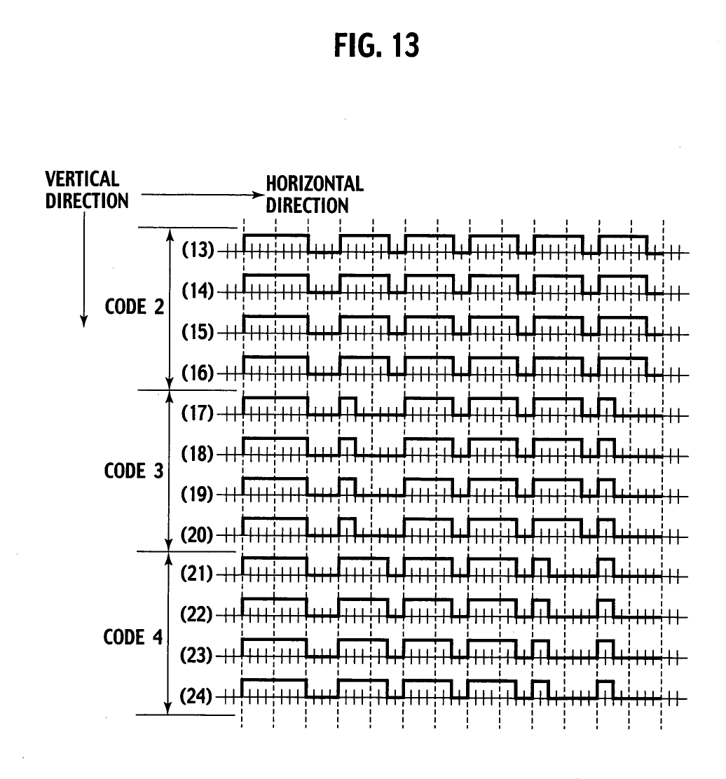

FIGS. 12 and 13 show a synchronization signal and codes according to an embodiment of the present invention. In FIG. 12, first line (1) to eighth line (8) are a two-dimensional positive synchronization signal to be separated from an image. The two-dimensional positive synchronization signal is vertically inverted line by line when an interlace method is employed and every two lines when a sequential scanning method is employed. In FIG. 12, odd lines for an odd field and even lines for an even field are overlaid.

In FIGS. 12 and 13, a horizontal scale indicates a base period, which corresponds to a pixel or a plurality of pixels. To lower horizontal correlativity, the number of pixels in one basic period must be small. According to an embodiment of the present invention, the basic period consists of a pixel and horizontal correlativity is evaluated over four and eight pixels.

To separate a two-dimensional positive synchronization signal from an image having correlativity, adjacent pixels with low correlativity of the two-dimensional positive synchronization signal must be evaluated. When devices are connected though analog interfaces, incomplete reproduction of a synchronization signal and the influence of distortion in a transmission line on pixel signals must be considered. The present invention assumes that no phase lock occurs on a reproduced synchronization signal, a residual phase error changes depending on situations, and a transmission path has a sufficient quality for recording/reproducing a video tape recorder. Analog interfaces loosely manage a roll-off rate in the frequency characteristics of a transmission path, and therefore, it is difficult to detect a sensitive synchronization signal. If correlativity between pixels that are too far from each other is evaluated by excessively considering influences on a transmission path, no correlativity will be found and erroneous detection will be made.

In consideration of these matters, an embodiment of the present invention forms a two-dimensional positive synchronization signal by inverting, in a horizontal direction, pixels at intervals of four and eight. At the same time, the embodiment inverts, in a vertical direction, an exclusive OR of horizontal eight pixels line by line when an interlace method is employed and every two lines when a sequential scanning method is employed. Namely, the embodiment prepares a two-dimensional positive synchronization signal by inverting pixels at different intervals in a horizontal direction. According to the embodiment, the different intervals are intervals of four pixels and eight pixels (there is some exception). In a vertical direction, the embodiment inverts an exclusive OR of pixels (eight pixels in this example) between lines. By detecting these characteristics, the two-dimensional positive synchronization signal can be extracted. This will be explained in detail later.

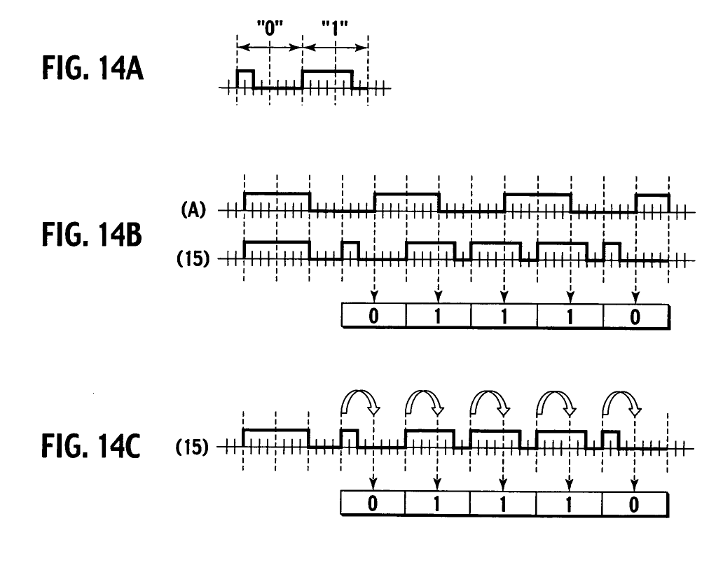

Codes that follow the synchronization signal will be explained. A code is expressed with 1s and 0s and each code is used to control a connected electronic device. FIG. 14A shows a signal representative of 1 and 0. The value 1 or 0 is defined with a pulse width in a period of eight pixels. If two pixels at the start of an eight-pixel period are high, it is 0. If six pixels at the start of an eight-pixel period are high, it is 1. Based on these definitions, there will be two determination methods as shown in FIGS. 14B and 14C. In FIG. 14B, a pulse signal (A) is phase-adjusted according to a synchronization signal. At a rise of the pulse signal (A), a signal on the fifteenth line (15) is fetched as data by a flip-flop. In FIG. 14C, first eight pixels of high level serve as a header. After confirming the header and four blank (low-level) pixels that follow the header, a fourth pixel from every rise of data is checked to see if it is high or low with the use of a flip-flop.

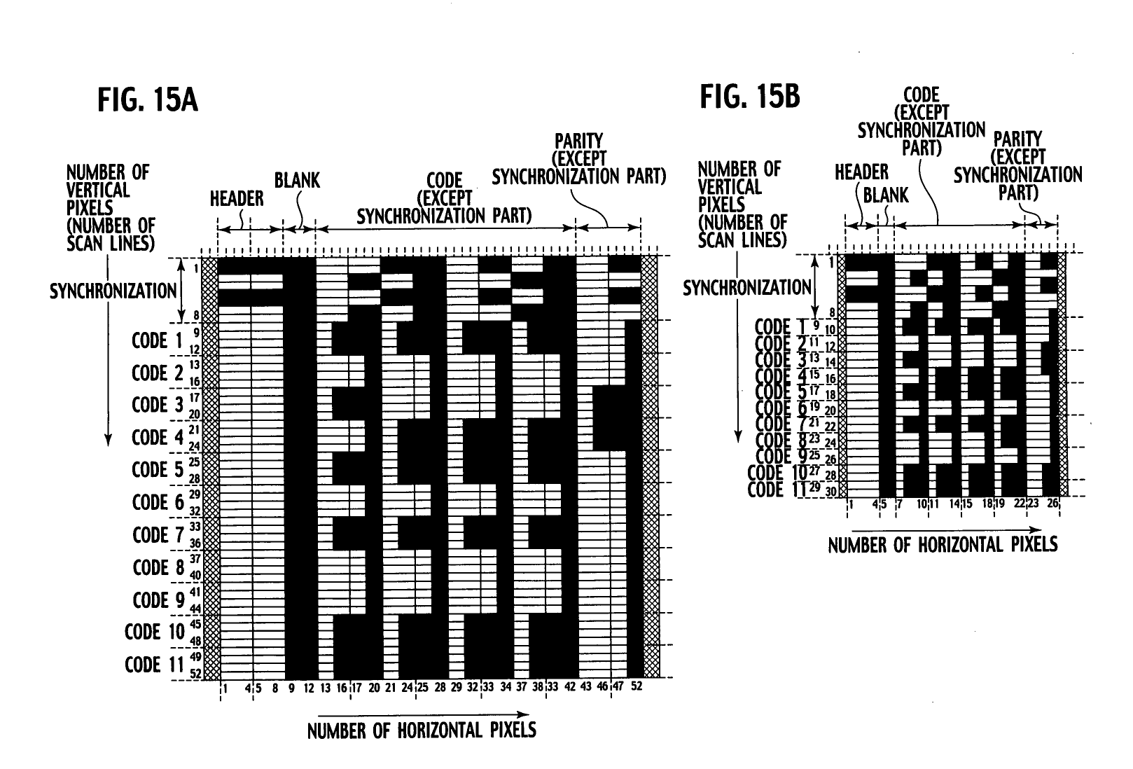

According to the embodiment, each line includes five data bits to form one code, and the same code is embedded in four lines per frame. Namely, the same code is embedded in two lines in the case of an interlace scanning method and in four lines in the case of a sequential scanning method. FIG. 15A is a view showing codes according to the embodiment. In an interlace scanning method, odd lines and even lines are transferred in two fields which form a frame. In one frame, a synchronization signal takes eight lines, one code takes four lines, and there are eleven codes. Namely, the synchronization signal and eleven codes take 52 lines in total in one frame. In one line, a header takes eight pixels, a blank period takes four pixels, and five-bit data takes 40 pixels. Namely, one code takes 52 pixels in total in one line. This configuration is only an example and may be changed depending on specifications. The horizontal width of the synchronization signal may be repeated up to a maximum data region. Longer the horizontal width, the smaller an erroneous detection. This, however, deteriorates transfer efficiency. Accordingly, a proper data amount must be set. FIG. 15B shows a different pattern of codes. The pattern of FIG. 15B is half that of FIG. 15A in horizontal and vertical directions. When analog interfaces of good quality or digital interfaces are employed, a code pattern with high transfer efficiency such as the pattern of FIG. 15B may be used to increase an information transfer rate. The embodiments mentioned here employ the pattern of FIG. 15A as a standard pattern.

The universal network GUI according to the present invention receives a control menu from any one of the external electronic devices 21 to 24 connected to the television set 1 (FIG. 8), displays the control menu, allows a user to select one of the control buttons and icons in the displayed control menu, and transmits a control signal corresponding to the selected control button or icon to the corresponding external electronic device through a corresponding one of the external device remote controllers 61 to 64. The universal network GUI according to the present invention releases the user from operating the remote controllers 61 to 64 of the external electronic devices 21 to 24. Namely, the user can operate the external electronic devices 21 to 24 through operation only on the television set 1. According to the present invention, control information transferred from the external electronic devices 21 to 24 to the television set 1 is based on the existing remote control codes of the remote controllers of the devices 21 to 24 because the external electronic devices 21 to 24 are controlled by the existing remote control codes in the end. Accordingly, there is no need for the present invention to establish new standards for achieving the present invention. Use of the existing remote control codes is advantageous because the codes can be converted into infrared rays without decoding them.

There are known remote control codes prepared by Association for Electric Home Appliances. Presently, these codes are rarely used. At present, individual manufacturers make their own remote control codes and use them for their own products. In the market, there are remote controllers that can handle remote control codes of all manufacturers. Namely, the remote control codes of all manufacturers are available to use. If a television set is connected to an external electronic device and if the manufacturer of the external electronic device is known, it will be possible to adjust the remote controller of the television set to the remote control codes of the manufacturer and control the external electronic device with the remote controller of the television set.

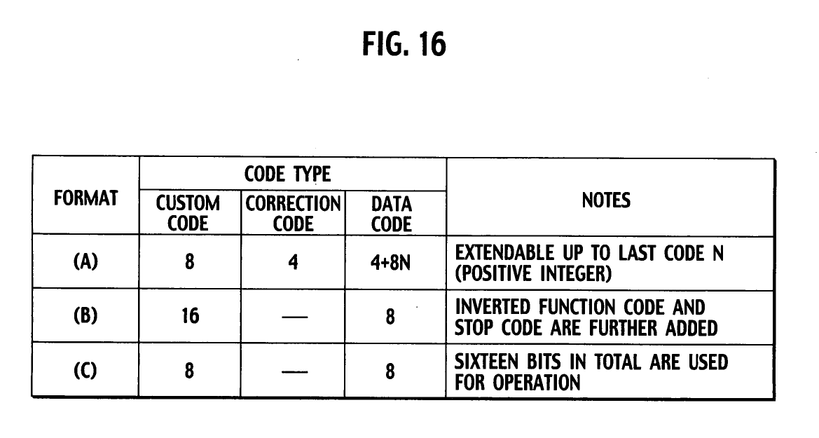

FIG. 16 is a list of remote control code formats presently used by manufacturers. The list shows the number of bits for remote control codes. In the table, a custom code is used to identify the manufacturer of an objective device and what the objective device is (television set, VTR, or the like). A data code represents operation codes to control operation (play, fast feed, and the like) of the device. In the table, the minimum number of bits of a format (A) is 24, that of a format (B) is 24 including an inversion code, and that of a format (C) is 16. Namely, the minimum number of bits for remote control codes necessary for an embodiment of the present invention is 16. To cope with various manufacturers and methods, the number of bits for remote control codes may be 32. This number will be sufficient to identify the manufacturer and type of each external electronic device connected to a television set and control the functions of the external electronic device.

In FIG. 15A, codes embedded in a control menu according to an embodiment of the present invention use 52 horizontal pixels and 52 vertical lines. The total of 55 bits (5 bits×11 codes) to be embedded according to the present invention sufficiently covers 32 bits necessary for remote control codes. The fifth horizontal bit in each code may be used as a parity code or a checksum code. In this case, 44 bits may be used for remote control codes. In FIG. 15A, codes 1 to 8 are assigned to remote control codes and codes 9 to 11 are assigned to extension codes. The extension codes may be used for achieving a plurality of actions such as pushing buttons of 3, 2, and 5 to select a channel of 325.

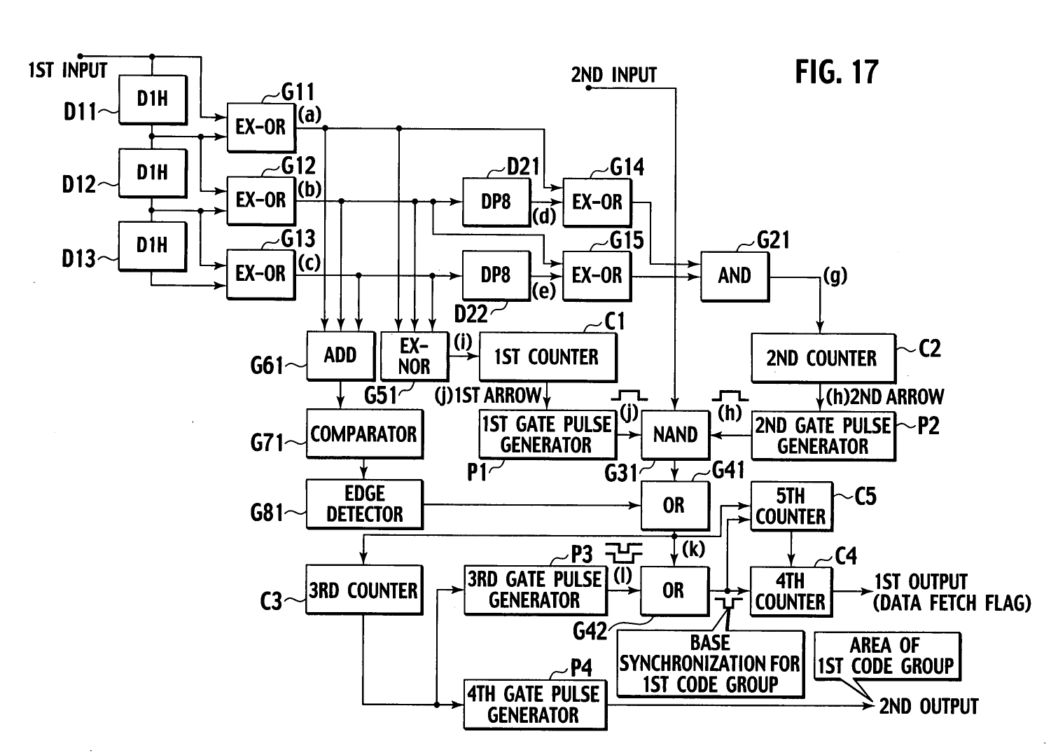

A method of reproducing a two-dimensional positive synchronization signal will be explained. FIG. 17 is a block diagram showing a configuration (synchronization signal detector) to detect a two-dimensional positive synchronization signal. The synchronization signal detector includes delay units D11, D12, and D13 to delay an input signal by one horizontal period, exclusive OR (EX-OR) circuits G11, G12, G13, G14, and G15, delay units D21 and D22 to delay an input signal by a time of eight pixels, an AND circuit G21, counters C1, C2, C3, C4, and C5, gate pulse generators P1, P2, P3, and P4, a NAND circuit G31, OR circuits G41 and G42, an exclusive NOR (EX-NOR) circuit G51, a full adder G61, a comparator G71, and an edge detector G81. In FIG. 17, (a), (b), and (c) are outputs from the EX-OR circuits G11, G12, and G13, (d) and (e) are outputs from the delay units D21 and D22, (g) is an output from the AND circuit G21, and (j), (h), and (l) are outputs from the gate pulse generators P1, P2, and P3. A first input is a video signal, and a final output includes a first output and a second output.

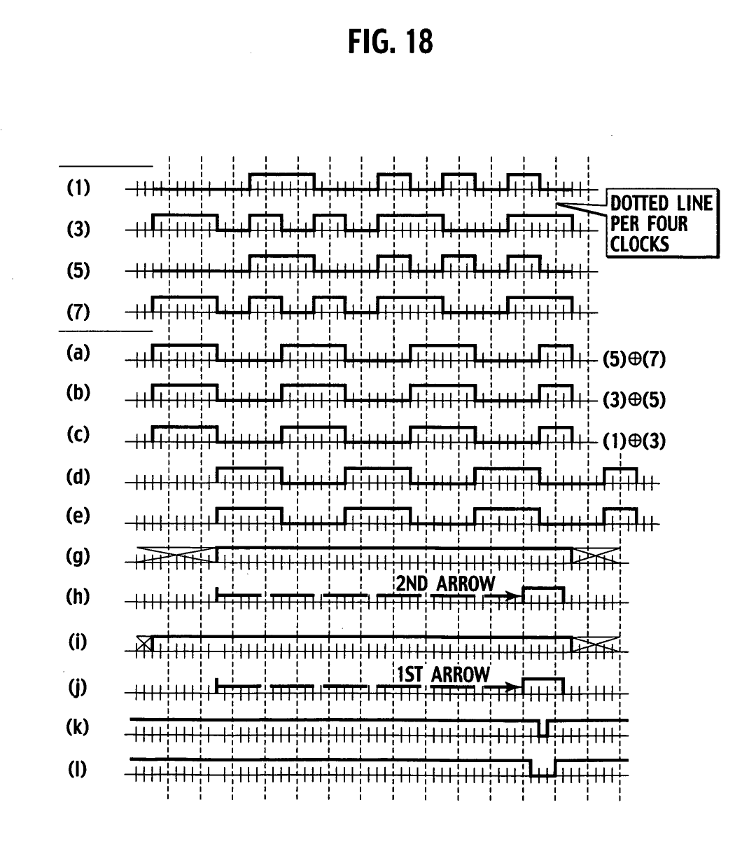

A two-dimensional positive synchronization signal is detectable in any one of odd and even fields. This embodiment detects the signal in an odd field. FIG. 18 is a timing chart explaining detection of a two-dimensional positive synchronization signal. Lines (1), (3), (5), and (7) of FIG. 18 correspond to the odd lines (1), (3), (5), and (7) of FIG. 12. The characteristics of signals in the odd lines are obtained to provide a two-dimensional positive synchronization signal. Waveforms (a) to (l) indicate waveforms of intermediate outputs in the respective stages of FIG. 17. The outputs (a), (b), and (c) of the EX-OR circuits G11, G12, and G13 invert at intervals of eight pixels as shown in FIG. 18. The outputs (b) and (c) are delayed by eight pixels in the delay units D21 and D22, which provide the outputs (d) and (e). If the outputs (a), (b), (c), (d), and (e) each have intervals of eight pixels, the AND circuit G21 of FIG. 17 provides the output (g) of FIG. 18 showing continuous high-level periods. This high-level continuity indicates that the signals in the odd lines agree with one another in horizontal and vertical directions. The second counter C2 counts the high-level periods. If the output (g) of FIG. 18 is high for a period indicated with a second arrow on the output (h), the second counter C2 provides a signal to the second gate pulse generator P2, which provides a gate pulse shown in the output (h) of FIG. 18. The second counter C2 is reset when first fall edges of the waveforms (a), (b), and (c) align with one another. Protection is made so that no reset pulse is produced at fall edges that follow the first fall edges.

After confirming that the waveforms (a), (b), and (c) of FIG. 18 agree with each other, a gate pulse of another system is generated. This confirmation of agreement of the waveforms (a), (b), and (c) is made only in the vertical direction and needs along time, and therefore, is carried out for protection. If the vertical agreement is confirmed, the EX-NOR circuit G51 continuously provides a high-level output (i) of FIG. 18. In the waveforms (i) and (g) of FIG. 18, a period indicated with “X” relates to a video signal period, and therefore, has an indefinite value. The first counter C1 counts a period indicated with a first arrow on the waveform (j) of FIG. 18 and provides a signal to the first gate pulse generator P1. In response to the signal, the first gate pulse generator P1 provides a gate pulse shown in the waveform (j) of FIG. 18. The first counter C1 is reset when first fall edges of the waveforms (a), (b), and (c) align with each other. The NAND circuit G31 provides a low output when the gate pulse waveforms (j) and (h) and a second input become high. The output pulse of the NAND circuit G31 is used to gate a reference synchronization signal.

It is assumed that a horizontal synchronization signal for images involves no residual phase error in a clock of each pixel and no jitter. Then, the gate pulses of (h) and (j) are stably obtained by counting the first arrow in (j) and the second arrow in (h) and by confirming the continuity of (g) and (i). If there is unstableness, the gate pulses are stably obtained by counting the continuity of the waveforms (g) and (i) at intervals of four clocks indicated with dotted lines. In FIGS. 12, 13, and 14, each dotted line corresponds to a phase change point of a synchronization signal. In FIG. 18, each dotted line is shifted by two clocks from a phase change point and at which there is no phase change in a synchronization signal. In FIG. 18, the same level is kept one clock before and after the dotted line. Namely, at the dotted line, there will be no change in a detected level even if a phase clock is insufficient. The phase based on four clocks is determined according to the horizontal synchronization signal for images.

The outputs (a), (b), and (c) are supplied to the adder G61. If the signals on the four lines agree with one another in the adder G61, the same waveform will be repeated and the adder G61 provides 3. Whether the output of the adder G61 is equal to or greater than 3 (1 or 2 is also acceptable) is checked by the comparator G71. The functions of the adder G61 and comparator G71 may be simplified by making the adder G61 as a one-bit full adder which has two inputs and a carry input to receive the waveforms (a), (b), and (c), respectively, and provides a carry output. The output of the comparator G71 is the same as the waveforms (a), (b), and (c) and provides no high-level output if any one of the waveforms (a), (b), and (c) differs from the others. Accordingly, the comparator G71 secures protection and improves resistivity against noise. The edge detector G81 provides a one-pixel pulse at a rise of a pulse. The edge detector G81 provides a plurality of pulses in a line time of the waveform (c) of FIG. 18. The pulses of the edge detector G81 are gated by the NAND circuit G31, to provide the reference synchronization signal (k) of FIG. 18.

The reference synchronization signal is protected in a temporal direction with the third counter C3 and third gate pulse generator P3. The third counter C3 counts a frame with a resolution of pixels. Based on a counted value, the third counter C3 can provide a pulse of an optional phase and width. According to the count value of the third counter C3, the third gate pulse generator P3 generates the waveform (1) of FIG. 18, and the OR circuit G42 provides a gated reference synchronization signal. The gate signal (1) of FIG. 17 may be slightly widened to secure stability. The fourth counter C4 counts the reference, synchronization signal up to a predetermined value and provides a flag (high-level flag) to indicate that data has been fetched. The predetermined value may be 5 to indicate that the reference synchronization signal has continuously been obtained for five frames, and therefore, synchronization has correctly been detected. The function of the fifth counter C5 will be explained later.

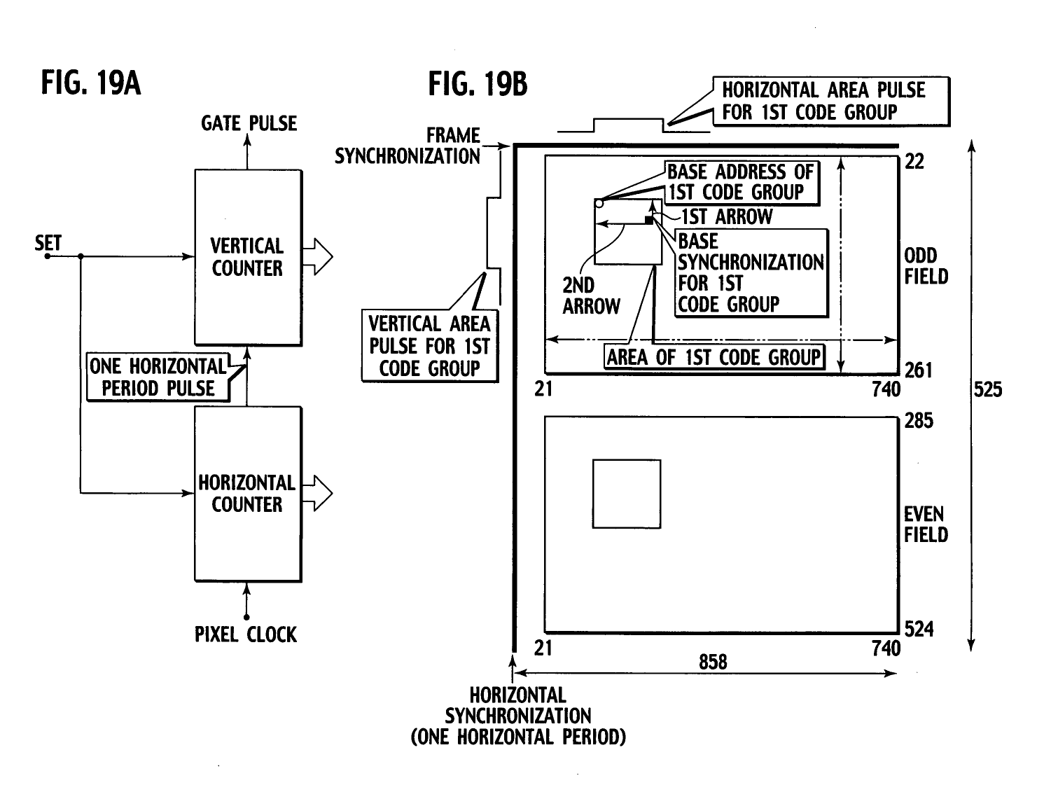

The fourth gate pulse generator P4 provides, for example, a low-level pulse to indicate one code group zone. The pulse is supplied to a second input of a synchronization detector that detects another code group, so that the same code group will not be detected repeatedly and codes are sequentially connected in order of priority. FIGS. 19A and 19B show a reference synchronization signal and a zone pulse for a code group. More precisely, FIG. 19A is a block diagram showing the third counter C3 of FIG. 17 that counts the number of horizontal pixels and the number of vertical lines. The count values are shown in FIG. 19B. FIG. 19B shows a model of a video signal. The video signal is sampled at a sampling frequency of 13.5 MHz to provide horizontal pixels and vertical lines whose numbers are as shown in FIG. 19B. An effective area of the video signal contains codes, and a reference synchronization signal is present at a position shown in FIG. 19B. If the reference point must be set at a left end of the code group, the reference point may be shifted in a screen space. In this way, the third counter C3 synchronizes with the reference synchronization signal, to optionally set a zone pulse for a code group. Namely, a pulse for extracting data may optionally be set.

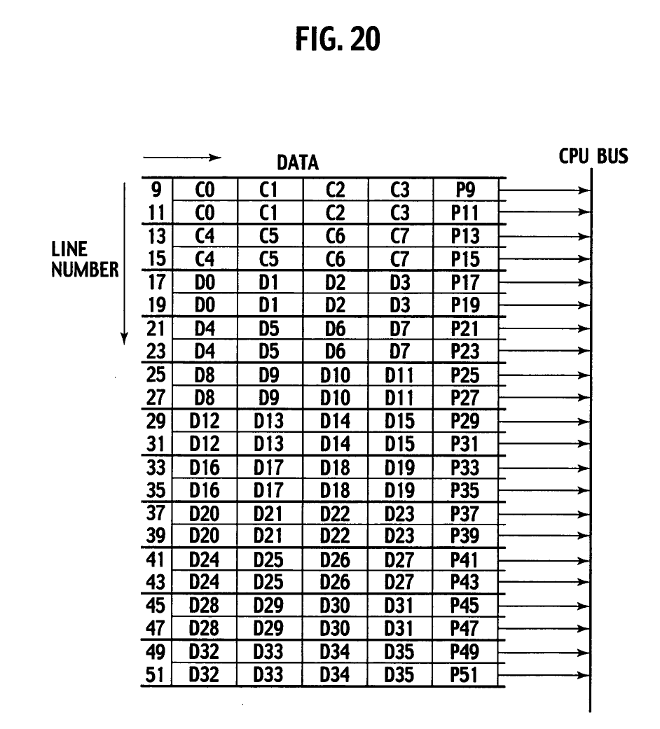

FIG. 20 shows a relationship between a line of a video signal and data to be forwarded. A left end of FIG. 20 shows line numbers of a video signal. Line numbers 1 to 8 used for a two-dimensional positive, synchronization signal are omitted in FIG. 20. Only odd lines for interlace scanning are shown in FIG. 20. Cells C0, C1, C2, and the like on the right side of the line numbers are one-bit data consisting of eight pixels. The same data is transmitted in consecutive two lines (four lines in a frame). Accordingly, the first to fourth bits of the lines 9 and 11 are the same. The fifth bits (P9, P11, P13, and the like) are different from one another as explained later. These conditions are applicable to the lines 13 and 15 and the lines that follow. The above-mentioned reference synchronization signal provides a pulse for locating each data piece. Data in each cell of FIG. 20 is supplied to a data input of a flip-flop, and a pulse based on the reference synchronization signal is supplied to a clock input of the flip-flop, to extract the data. According to this embodiment, every two lines (four lines in a frame) provides the same data. The data thus obtained is transferred per field or frame to a CPU through a CPU bus, and the CPU recognizes the contents of the data.

The contents of the data are not specifically limited. According to the embodiment, data is up to the fourth bit in each line and the fifth bit is used as a parity bit to detect an error. The fifth bit for parity may be used as a checksum value to detect an error in data as a whole. According to the embodiment, it is assumed that no change is made in the contents of data in the same screen, and therefore, data in which an error is found is simply discarded. Namely, there is no need of an error correcting function. This means that the embodiment can employ a very simple error detection function. This is advantageous in data transmission.

An icon replacement will be explained. In FIG. 9, the television screen A shows codes transferred from an external electronic device as they are. This is inappropriate for a user friendly GUI. Although raw codes such as two-dimensional bar codes are frequently seen, they are not visually smart. The raw codes of the screen A may be replaced with icons shown in the screen B of FIG. 9, to improve visibility and usability so that a user may grasp operations represented with the icons at a glance.

A way of obtaining icons in a television set will be explained. Icons for basic operations such as play and stop of, for example, a VTR that is frequently connected to a television set are stored in advance in the television set, so that control codes may easily be replaced with the icons such as those shown in the screen B of FIG. 9. This, however, is not a true solution for a variety of control operations. Icons to be displayed are fixed. To display icons of special design or icons for special functions of external electronic devices on a television set, it is necessary for the external electronic devices to transfer icon data to the television set.

The universal network GUI according to the present invention embeds icons in a code area, or an area specified with a code, or a predetermined area in a time sharing manner, so that a television set may fetch the icons into a memory and display the fetched icons. Detecting the timing of icons transmitted instead of codes will be explained. One technique is to periodically changing the contents of synchronization signals or codes to make the timing detectable. According to an embodiment of the present invention, one bit in a code is changed.

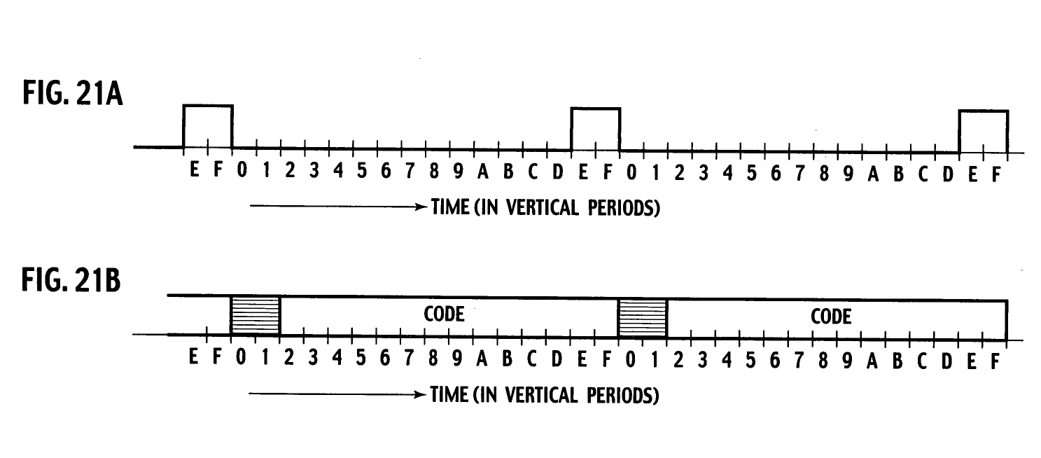

FIG. 21A shows a change in a bit of code to establish temporal synchronization. A code to be changed is not specified in this example but it must be defined when developing a product. The temporal synchronization is also achievable by changing part of a two-dimensional positive synchronization signal in such a way as not to affect synchronization detection. FIG. 21B shows periods for sending codes and icons. In FIG. 21B, a hatched part is an icon transfer period. Each division of FIGS. 21A and 21B corresponds to one vertical period. This embodiment transfers codes frame by frame, and therefore, the code of FIG. 21A is at high level for two vertical periods. To cope with an interlace signal, a period of time for transferring icons consists of two vertical periods.

During the transfer of icons, no two-dimensional positive synchronization signal is transmittable. This must be taken into account when detecting a two-dimensional positive synchronization signal. In FIG. 17, the fifth counter C5 counts a period (a frame according to the embodiment) in which no reference synchronization signal is detected. This count value may be set to be equal to or greater than 2 (corresponding to four vertical periods) so that a two-dimensional positive synchronization signal is surely detected. When the fourth counter C4 detects a reference synchronization signal for five or more frames, synchronization is established with a data fetch flag being set. If no synchronization signal is detected for two or more frames, asynchronism is found. A frame (two vertical periods) containing icons is transmitted at intervals of eight frames (16 vertical periods), and therefore, synchronization can always be established.

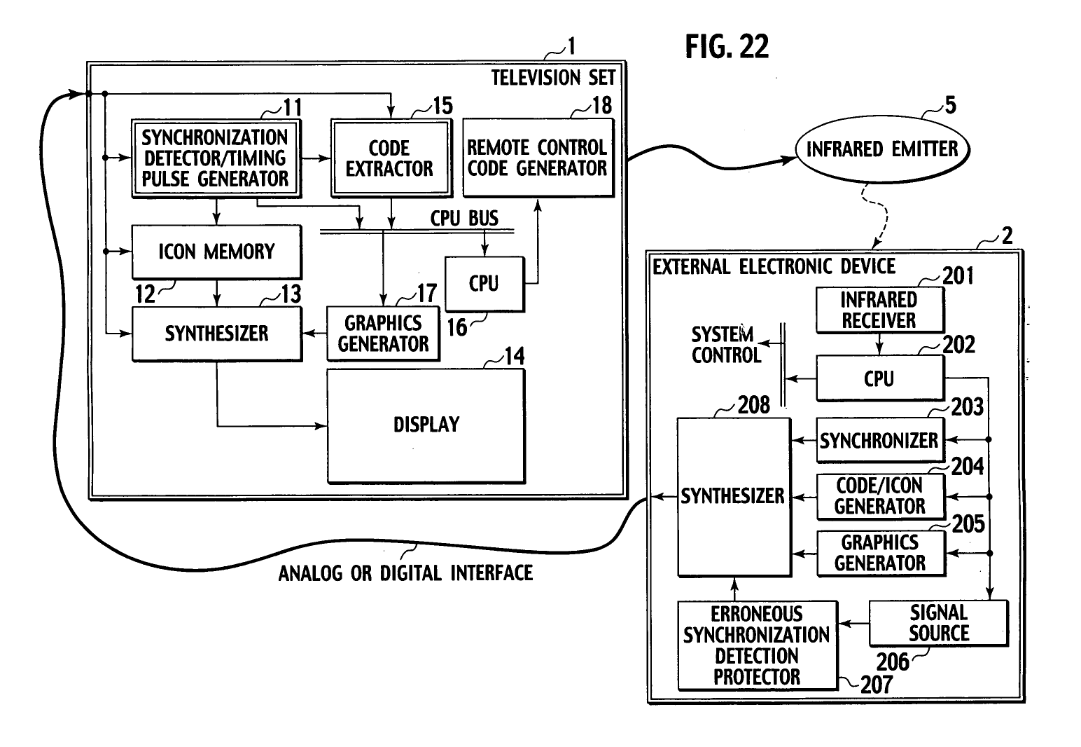

FIG. 22 is a block diagram showing a two-way system employing the universal network GUI according to the present invention. In FIG. 22, a television set 1 is connected to an external device remote controller 5 of infrared rays and an external electronic device 2. Although there is one external electronic device in FIG. 22, a plurality of external electronic devices may be connected to the television set 1 with the same relationship being established among the television set 1, external device remote controller, and external electronic device.

In FIG. 22, the television set 1 is connected to the external electronic device 2 through an analog or digital interface. The external electronic device 2 transfers a GUI image including control codes and icons to the television set 1 as mentioned above. In the external electronic device 2, a synchronizer 203 generates a two-dimensional positive synchronization signal and sends the same to a synthesizer 208. A code/icon generator 204 prepares a time sharing signal representative of control codes and icons and sends the signal to the synthesizer 208. A graphics generator 205 prepares other character and graphics information and sends it to the synthesizer 208. If the external electronic device 2 is a storage medium, a signal source 206 provides a reproduced signal. If the device 2 is a tuner, the signal source 206 provides a video signal corresponding to a broadcasting signal. An erroneous synchronization detection protector 207 protects the video signal against a two-dimensional positive synchronization signal and sends the signal to the synthesizer 208. The synthesizer 208 synthesizes these input signals into a GUI image signal representing a control menu, which is transmitted to the television set 1 through the analog or digital interface.

The GUI image signal sent from the external electronic device 2 to the television set 1 is sent to a synchronization detector/timing pulse generator 11, a code extractor 15, an icon memory 12, and a synthesizer 13. The synchronization detector/timing pulse generator 11 separates the two-dimensional positive synchronization signal from the GUI image signal and generates pulses necessary for function blocks.

According to the pulses from the synchronization detector/timing pulse generator 11, the icon memory 12 fetches icon images embedded in the GUI image signal and stores them pixel by pixel. An AD converter necessary for the analog interface is omitted in FIG. 22. If an error occurs in the data, the control codes will be altered to cause a serious problem. To prevent this, the embodiment forms each data bit with eight pixels. An icon is an image and produces no problem even if some distortion is caused through an analog interface, and therefore, can be processed pixel by pixel.

The synthesizer 13 receives icons from the icon memory 12 and replaces control codes to be displayed at predetermined locations on a screen with icons. Then, the synthesizer 13 synthesizes the icon images, the input GUI image, and an information image of the television set prepared by the graphics generator 17. The synthesized image from the synthesizer 13 is displayed on a display 14.

The GUI image displayed on the display 14 may be the one shown in the television screen B of FIG. 9. A user watching the display 14 may select one of the displayed control icons. To select one of the icons, the user may manipulate UP, DOWN, LEFT, RIGHT, and OK buttons on an existing remote controller. Alternatively, the user may employ an icon selector that uses images picked up by a video camera connected to the television set. Any icon selection unit is usable according to the present invention. To clearly show the user which of the icons is selected, a cursor may be added to the bottom of the selected icon. This sort of operation is carried out by the graphics generator 17 in the television set 1.

The code extractor 15 in the television set 1 extracts codes as explained with reference to FIG. 20, and sends the extracted control codes to a CPU 16 through a bus. When the user selects an icon in the GUI image displayed on the television set 1, the CPU 16 decodes the selected icon with software and sends a control code corresponding to the selected icon to a remote control code generator 18. It is preferable that the codes embedded in the GUI image signal from the external electronic device 2 are remote control codes used for the external electronic device 2. Manufacturers usually define and use their own remote control codes. To achieve the present invention, manufacturers are only required to disclose their own remote control codes, and the present invention performs standardization of the manufacturers' codes without forming new unified codes.

In response to the control code from the remote control code generator 18, an infrared emitter of the external device remote controller 5 emits infrared rays. The infrared rays are received by an infrared receiver 201 of the external electronic device 2. The infrared receiver 201 converts the infrared rays into pulses and sends them to a CPU 202. The CPU 202 decodes a control code represented with the pulses and controls the external electronic device 2 accordingly. If the device 2 is a video tape recorder, the control operation may be play, stop, or the like.

The erroneous synchronization detection protector 207 of the external electronic device 2 shown in FIG. 22 will be explained. When a menu or an image is converted into binary data, the binary data may have the same waveform as a two-dimensional positive synchronization signal. In this case, there is a probability that the television set 1 erroneously detects the menu or image waveform as a two-dimensional positive synchronization signal. To avoid this, the protector 207 adds an error signal to a signal provided by the signal source 206. The two-dimensional positive synchronization signal is prepared to have a correlativity pattern that rarely appears in video signals. It is necessary, however, to improve the correctness and security of the two-dimensional positive synchronization signal. At this time, menu images rarely interfere with the synchronization signal because the contents of the menu images can be known in advance for confirmation. On the other hand, video signals involve a variety of patterns, and therefore, may interfere with the synchronization signal. The erroneous synchronization detection protector 207 solves this problem.

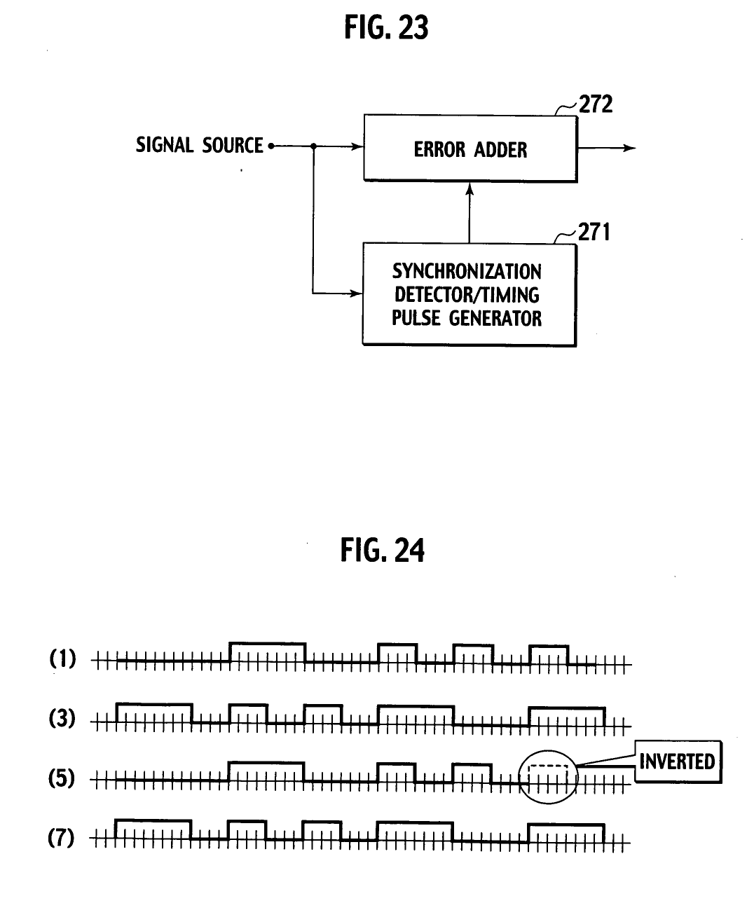

FIG. 23 is a block diagram showing an example of the erroneous synchronization detection protector 207. An output signal from the signal source 206 (FIG. 22) is divided into two, one of which is supplied to a synchronization detector/timing pulse generator 271 and the other to an error adder 272. The synchronization detector/timing pulse generator 271 is the same as the synchronization detector/timing pulse generator 11 of the television set 1 of FIG. 22. The synchronization detector/timing pulse generator 271 of FIG. 23 detects a two-dimensional positive synchronization signal from a video signal sent from the signal source 206 (FIG. 22) in the same manner as that mentioned above. At this time, a pattern of four lines is checked and repetition in a temporal direction is examined. If a predetermined number of repetitions is found in the temporal direction, the synchronization detector/timing pulse generator 271 sends a signal to the error adder 272. In response to the signal, the error adder 272 slightly changes the video signal so that the video signal will not coincide with the two-dimensional positive synchronization signal. FIG. 24 shows an example of a signal changed by the error adder 272 because the signal has the same pattern as the two-dimensional positive synchronization signal. In FIG. 24, a line (5) includes a part indicated as “Inverted.” This part is the part changed by the error adder 272. With this change (inversion), this video signal is never detected as a two-dimensional positive synchronization signal by the television set 1. This technique of the present invention can correctly separate error codes and icons from video images that involve a variety of signal patterns. The first embodiment of the present invention mentioned above is applicable to analog and digital interfaces.

The second embodiment of the present invention will be explained. The second embodiment is applicable only to digital interfaces. Namely, a two-dimensional positive synchronization signal and control codes are embedded and transmitted in digital data.

According to the first embodiment, icons are transferred to a television set in a time sharing manner and are stored in an icon memory, so that a two-dimensional positive synchronization signal is extracted and control codes are replaced with the stored icons. This method is applicable to both the analog and digital interfaces. By limiting the application of the present invention to digital interfaces, the necessity of replacing control codes into icons with the use of an icon memory is eliminated and a two-dimensional positive synchronization signal and control codes can be embedded in a manner the embedded data is substantially invisible to users. The second embodiment embeds a two-dimensional positive synchronization signal and control codes in LSBs of a digital video signal so that the embedded data is visually uninfluential. The second embodiment extracts a reference synchronization signal in the same manner as the first embodiment.

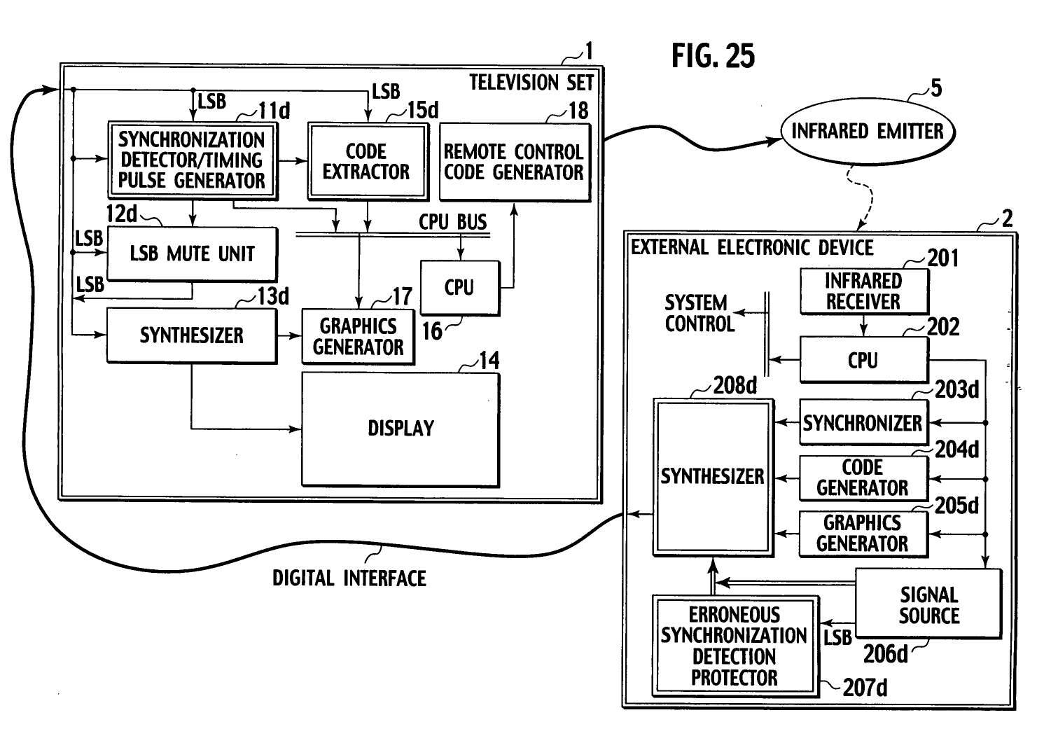

FIG. 25 is a block diagram showing a system according to the second embodiment of the present invention. The system of FIG. 25 is basically the same as the system of FIG. 22, and therefore, parts specific to digital signals in FIG. 25 will be explained. In FIG. 25, a signal source 206d of an external electronic device 2 provides an eight-bit digital signal. An erroneous synchronization detection protector 207d checks only an LSB of the signal, and higher seven bits are directly supplied to a synthesizer 208d. A synchronizer 203d provides a two-dimensional positive synchronization signal and a code generator 204d provides control codes. These signal and codes are synthesized in the synthesizer 208d with each LSB (eighth bit) of the digital video signal provided by the signal source 206d. The synthesized digital video signal from the synthesizer 208d is transmitted to a television set 1. A synchronization detector/timing pulse generator 11d and a code extractor 15d receive only LSBs of the digital video signal. The transmitted digital video signal is also supplied to a synthesizer 13d of the television set 1 with LSBs of the digital video signal muted by an LSB mute unit 12d. LSBs may interfere with the vision of a user if the LSBs have the same code pattern. To avoid this, the LSB mute unit 12d mutes the digital video signal by fixing LSBs of the signal to 0 or 1. This LSB muting is a simplest way. Like the first embodiment, there is a technique of employing a memory to replace only LSBs with predetermined data in a time sharing manner.

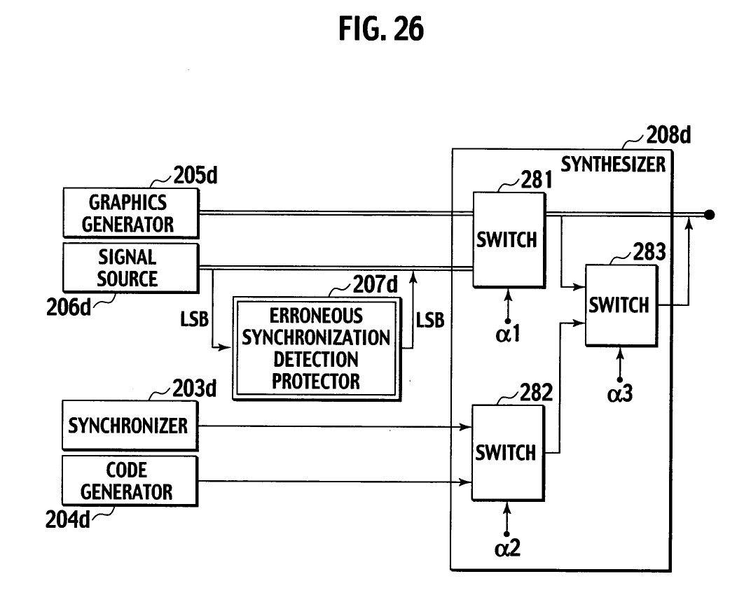

FIG. 26 is a block diagram showing part of the external electronic device 2 of FIG. 25, to embed a two-dimensional positive synchronization signal and control codes into a digital video signal. In FIG. 26, the synchronizer 203d generates a two-dimensional positive synchronization signal and the code generator 204d generates a control code. The signal and code are multiplexed in a switch 282 in a time sharing manner with a parameter of a2, to form one bit. This one bit becomes an LSB of a digital video signal. On the other hand, the graphics generator 205d and signal source 206d provide an eight-bit digital signal. An LSB of the digital video signal from the signal source 206d is checked by the erroneous synchronization detection protector 207d. If detects the same pattern as a two-dimensional positive synchronization signal, the protector 207d changes the LSB to protect the synchronization signal. The protector 207d is the same as that of the first embodiment. A switch 281 switches the digital signals from the graphics generator 205d and signal source 206d from one to another with the use of a parameter of a1. The LSB of an output signal from the switch 281 is replaced with the multiplexed two-dimensional positive synchronization signal and control code in a switch 283 with the use of a parameter of a3. As a result, the two-dimensional positive synchronization signal and control code are embedded in the LSB of the digital video signal, and at the same time, erroneous synchronization detection protection is carried out so that no error occurs even if the LSBs of a digital signal show the same pattern as a synchronization signal.

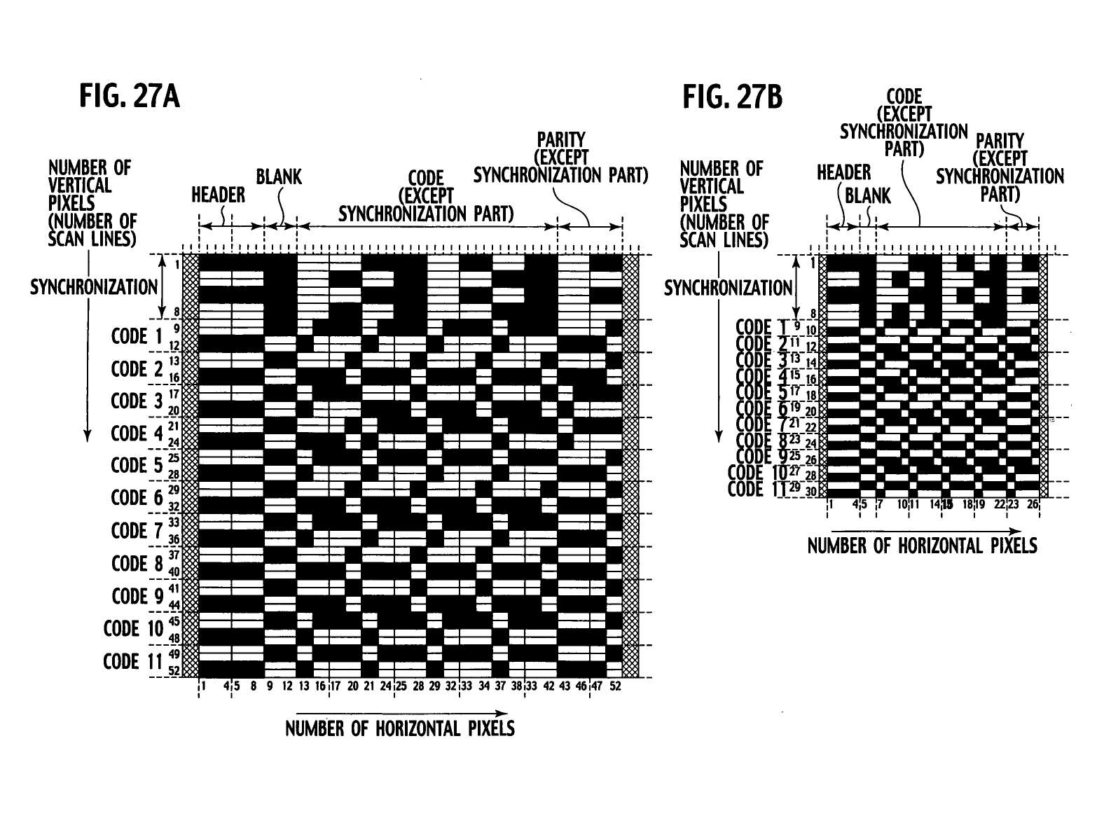

The LSBs of a digital video signal randomly vary, and therefore, are distinguishable from a regular signal such as a two-dimensional positive synchronization signal. If the LSBs of a digital video signal regularly change, they may easily be recognized as a pattern even if the change is small in amplitude. The pattern will be inconspicuous if it is in a high spatial frequency region. On a television set, the LSB pattern will be visible until LSBs are muted. In FIG. 15A, every two odd lines transmits the same two-dimensional positive synchronization signal or the same control code, and every two even lines transmits the same two-dimensional positive synchronization signal or the same control code. In FIG. 27A, a signal in a second odd line is the inversion of a signal in a first odd line. Similarly, a signal in a second even line is the inversion of a signal in a first even line. This increases spatial frequencies to make an LSB pattern inconspicuous. A pattern shown in FIG. 27B is made by halving the pattern of FIG. 27A in vertical and horizontal directions. Although not shown, a digital interface can correctly transmit data pixel by pixel, and therefore, horizontal components may be reduced further than those of FIG. 27B. According to the first embodiment, 0 and 1 for forming a code are represented with specific waveforms to overcome analog transmission distortion. In the case of a digital interface, each code may be made of one pixel, to improve transmission capacity.

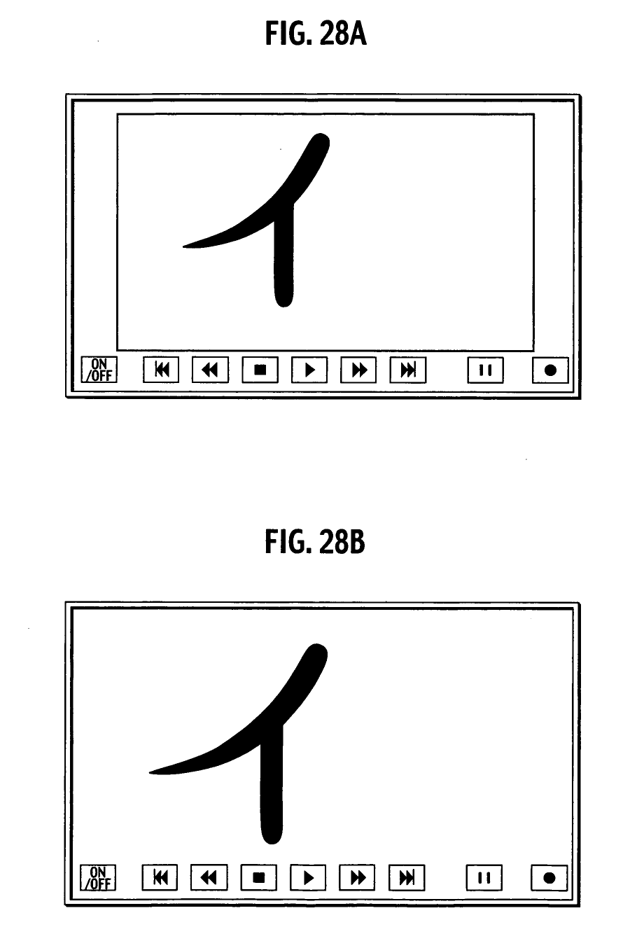

FIGS. 28A and 28B show application examples of the present invention. With reference to these drawings, effectiveness of the present invention will be explained. FIG. 28A shows a screen displayed on a television set. The screen shows an image and a menu synthesized by and transmitted from an external electronic device connected to the television set. The menu includes control icons representative of PLAY, STOP, and other control operations. The icons are extracted and displayed according to a two-dimensional positive synchronization signal sent from the external electronic device. Control codes for the external electronic device are recognized by the television set. By selecting one of the icons with a remote controller or any other pointing function of the television set, the external electronic device is controllable. FIG. 28B shows a screen displayed on a television set. In this example, icons are included in a video signal. In FIG. 28B, a two-dimensional positive synchronization signal is embedded in a video signal that varies in real time. Even in this case, the television set can detect the two-dimensional positive synchronization signal and extract control codes and icons like the example of FIG. 28A, according to the present invention.

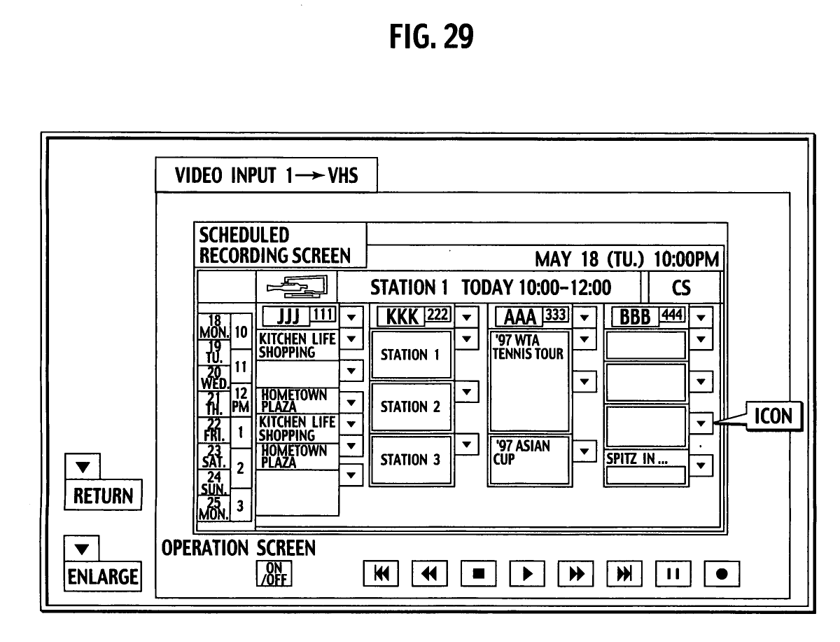

FIG. 29 shows a screen displayed on a television set. A menu shown in the screen is an EPG (Electronic Program Guide) sent from an external electronic device connected to a video input 1 of the television set. The EPG is used to record a program. Codes representative of programs of the EPG are sent with a two-dimensional positive synchronization signal to the television set, so that a user may record a program with the use of a remote controller of the television set. The EPG and PLAY and STOP icons displayed on the television set are sent from the external electronic device and are not original functions of the television set. In spite of this, the functions can centrally be controlled with the television set. New external electronic devices to be connected to the television set or new control functions added to the external electronic devices connected to the television set can also be controlled with the television set.

In this way, an external electronic device connected to a television set can be controlled by choosing control icons in a control menu of the external electronic device displayed on the television set with a remote controller or any other pointing operation of the television set. Namely, the external electronic device connected to the television set is controllable with the remote controller of the television set without manipulating a remote controller of the external electronic device. If the external electronic device is a hard disk recorder whose recording medium is permanently set in the recorder, the recorder may be arranged at a location that is unseen from the user. In this case, only by setting the external electronic device so that infrared rays from a remote controller of the external electronic device reach the device, the user can control the device from the television set. Although the second embodiment employs infrared external device remote controllers to control external devices, it is possible to control the external devices with digital interfaces without using the external device remote controllers. This is because the digital interface supports two-way communication. If control formats of the external devices are defined, the external devices are controllable without their own remote controllers by transferring control data through the digital interfaces.

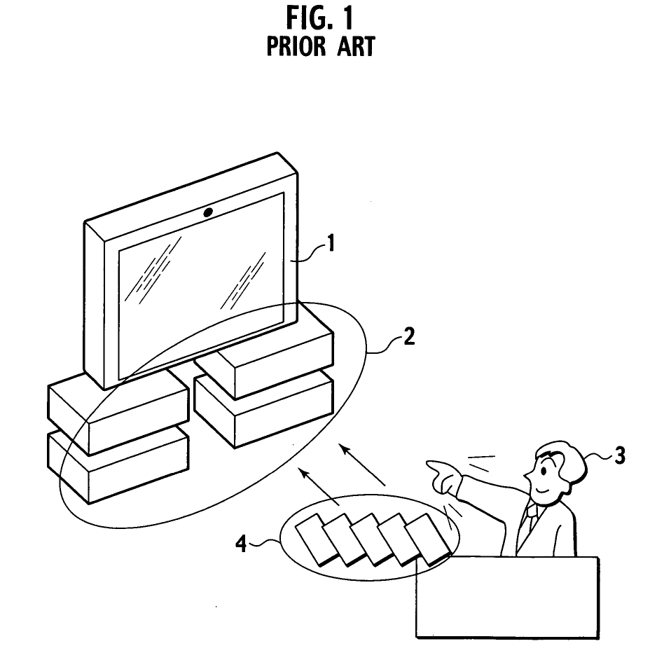

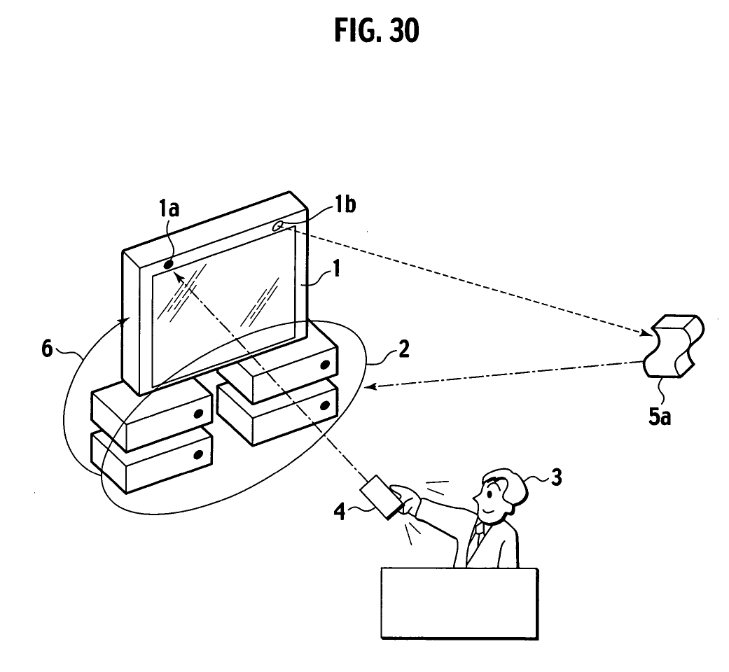

FIG. 30 shows an application example of the present invention using an infrared repeater. In FIG. 30, a television set 1 is connected to four external electronic devices 2 through analog or digital interfaces 6. The television set 1 has an infrared receiver 1a to receive infrared rays from a remote controller 4 of the television set 1 and an infrared emitter 1b. The infrared repeater 5a is arranged to face the electronic devices 2. In the example of FIG. 1, the number of remote controllers to be used is equal to the total number of the television set and external electronic devices. On the other hand, the example of FIG. 30 needs only one remote controller 4 of the television set 1. The external electronic devices 2 of FIG. 30 transfer control codes to the television set 1, which displays a menu representative of the control codes. When a user selects an item in the menu with the remote controller 4, a remote control code corresponding to the selected item is emitted as infrared rays from the infrared emitter 1b to the infrared repeater 5a. The infrared repeater 5a shapes the waveform of the received infrared rays and emits infrared rays based on the shaped waveform to the external electronic devices. In this example, the external electronic device remote controllers 61 to 64 of the external electronic devices arranged on the rack shown in FIG. 8 are not required. The infrared repeater 5a may realize control from the next room. Video signals and control codes may be communicated by radio between the external electronic devices and the television set 1 through wireless digital interfaces.

As mentioned above, the present invention sends control codes with video signals of any type of connection method and identifies a two-dimensional positive synchronization signal to extract the control codes. The present invention is applicable to any video transmission method that may employ an analog connection, a digital interface, a wired connection, or a wireless connection.

To control external electronic devices, the present invention employs infrared remote controllers of the external electronic devices or an infrared repeater. Accordingly, the present invention is achievable at low cost. Also, the present invention is achievable with manufacturers disclosing their own control formats. Even if control formats specific to manufacturers are undisclosed, the present invention is achievable by clarifying remote control codes specific to the manufacturers. The present invention can easily realize a home network. The present invention is consistent with other methods, to provide users with improved usability of AV devices.

Although the embodiments use remote control codes of external electronic devices to control the external electronic devices, any other codes may be used with two-dimensional positive synchronization signals. In a signal area where a control code is embedded, any other information piece instead of the control code may be embedded according to the present invention.

The universal network GUI according to the present invention uses a television set as a central information device among external electronic devices such as AV devices connected to the television set. By controlling a menu displayed on the television set, the user can remotely control any one of the external electronic devices. With the television set serving as a core of the external electronic devices connected to the television set, the user can grasp operation contents of the external electronic devices through the GUI screen. Even if new external electronic devices are connected to the television set, the user can easily operate them through the television set. The present invention is effective to improve the usability of electronic devices such as AV devices of various connection methods so that every user can easily operate the electronic devices.

It should be understood that many modifications and adaptations of the invention will become apparent to those skilled in the art and it is intended to encompass such obvious modifications and changes in the scope of the claims appended hereto.

What is claimed is:

1. An electronics system including at least one first electronic device with a display and at lest one second electronic device connected to the first electronic device,
the second electronic device comprising:
an information adder configured to add a synchronization signal and additional information containing information necessary for controlling the second electronic device to a predetermined area of a video signal to be transmitted to the first electronic device,
the first electronic device comprising:
an extractor configured to extract the additional information from the video signal transmitted from the second electronic device;
a control information provider configured to display, according to the extracted additional information, control information for controlling the second electronic device on the display; and
a forwarder configured to forward a control information piece to the second electronic device once the control information piece is selected by an operator from the control information displayed on the display,
the second electronic device executing a control operation according to the forwarded control information piece.

2. The electronics system of claim 1, wherein the forwarder is configured to forward the selected control information piece to the second electronic device through an infrared remote controller.

3. The electronics system of claim 1, wherein the information adder is configured to search an area of the video signal outside the predetermined area for the same pattern as the synchronization signal, and if the same pattern is found, change the part of the video signal in which the same pattern is found.

4. The electronics system of claim 1, wherein
the additional information added by the information adder includes icon information to be used to control the second electronic device; and
the control information provider is configured to display icons on the display according to the icon information, the icons serving as the control information.
